(19) United States
(12) Patent Application Publication
(10) Pub. No.: US 2026/0212435 A1
(43) Pub. Date: Jul. 23, 2026

(54) COMPUTER-BASED SYSTEMS AND/OR COMPUTING DEVICES CONFIGURED TO PROVIDE AUTOMATED ARBITRATION AS WELL AS MACHINE LEARNING ALGORITHMS AND GRAPHICAL USER INTERFACES RELATED THERETO

(71) Applicant: Fortuna Arbitration, Inc., Los Angeles, CA (US)

(72) Inventors: Kimo Gandall, Cambridge, MA (US); Kenny McLaren, Cambridge, MA (US)

(21) Appl. No.: 19/568,769

(22) Filed: Mar. 16, 2026

Related U.S. Application Data
(60) Provisional application No. 63/745,277, filed on Jan. 14, 2025.

(51) Int. Cl. G06Q 50/18; G06F 21/64

(52) U.S. Cl. CPC G06Q 50/182; G06F 21/64

(57) ABSTRACT

A system includes a processor configured to receive, from a claimant device, a claimant brief relating to a dispute; receive, from a respondent device, a respondent brief relating to the dispute; determine, based at least upon the claimant brief, the respondent brief, and rules derived from case law decisions, an outcome for the dispute; and generate a written decision indicative of the outcome. The written decision provides a rationale for the outcome and citations to the case law decisions supportive of the rationale and/or outcome. The processor is further configured to send, to the claimant device and the respondent device, the written decision.

### CROSS-REFERENCE TO RELATED APPLICATION

This application claims the benefit of and priority to U.S. provisional patent application Ser. No. 63/745,277, filed Jan. 14, 2025, the entire contents of which is hereby incorporated by reference in its entirety.

### TECHNICAL FIELD

The present disclosure relates generally to the provision of automated arbitration/dispute resolution and computer based systems, methods, and instructions stored on non-transitory computer readable media and executable by a processor for implementing the same. The present disclosure further relates generally to machine learning algorithms and graphical user interfaces (GUIs) for automated arbitration and dispute resolution, as well as computer based systems, methods, and instructions stored on non-transitory computer readable media and executable by a processor for implementing the same.

### SUMMARY

In some aspects, the techniques described herein relate to a computing device comprising: a memory and a processor coupled to the memory. The processor is configured to execute instructions stored in the memory to: receive, from a claimant device, a claimant brief relating to a dispute; receive, from a respondent device, a respondent brief relating to the dispute; determine, based at least upon the claimant brief, the respondent brief, and rules derived from case law decisions, an outcome for the dispute; and generate a written decision indicative of the outcome. The written decision provides a rationale for the outcome and citations to the case law decisions supportive of the rationale and/or outcome. The processor is further configured to send, to the claimant device and the respondent device, the written decision.

### BRIEF DESCRIPTION OF THE DRAWINGS

FIG. 1 illustrates a system for providing automated arbitration according to various embodiments.

FIG. 2 is a flowchart illustrating an example process for generating a final order or written decision for an arbitration according to various embodiments.

FIG. 3 is a flowchart illustrating another example process for generating a final order or written decision for an arbitration according to various embodiments

FIG. 4 is a flowchart illustrating an example process for preprocessing case law decisions and generating rules from the case law decisions according to various embodiments.

FIG. 5 is a flowchart illustrating an further preprocessing of case law decisions to generate rules according to various embodiments.

FIGS. 6-12 illustrate example graphical user interfaces of an automated arbitration system according to various embodiments.

FIG. 13 is a block diagram depicting a computer-based system and platform in accordance with one or more embodiments of the present disclosure.

FIG. 14 is a block diagram depicting another computer-based system and platform in accordance with one or more embodiments of the present disclosure.

### DETAILED DESCRIPTION

The following description of example methods and apparatus is not intended to limit the scope of the description to the precise form or forms detailed herein. Instead the following description is intended to be illustrative so that others may follow its teachings.

Described herein are various embodiments for implementing automated arbitration and dispute resolution between two parties, including through the use of various machine learning or artificial intelligence algorithms. Such algorithms may be first trained and then implemented for automated arbitration and dispute resolution after training. Further training may be done on already implemented algorithms to further refine the algorithms. Various embodiments described herein also provide graphical user interfaces (GUIs) that improve upon the functioning of previous GUIs, such that automated arbitration and dispute resolution is implemented using the various embodiments described herein.

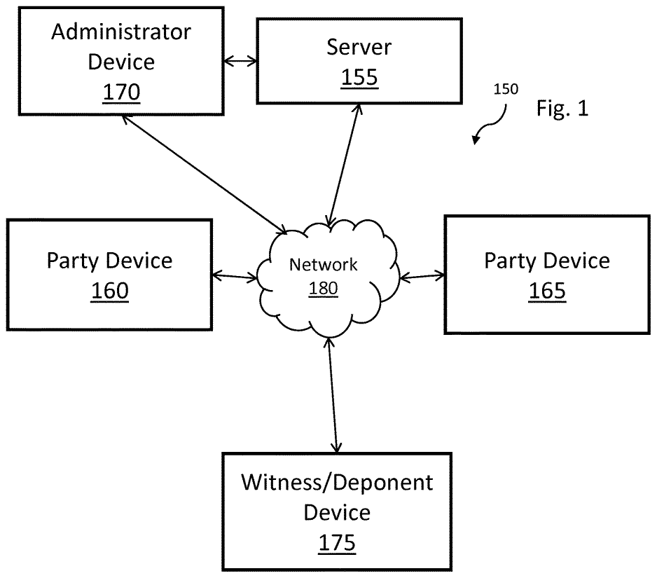

FIG. 1 is a high-level diagram of an example arbitration system 150. As shown in FIG. 1, the arbitration system 150 may include a server 155, a first party device 160, a second party device 165, an administrator device 170, and a witness/deponent device 175. In some embodiments, the server 155, the first party device 160, the second party device 165, the administrator device 170, and the witness/deponent device 175 may each be computing devices configured to exchange data over a network 180. The network 180 may provide communication paths among the illustrated devices such that information associated with an arbitration may be transmitted, received, and processed by the respective devices.

The server 155 may be configured to administer one or more arbitrations. In some embodiments, the server 155 may receive submissions from parties to a dispute, process information associated with the dispute, and perform one or more of the arbitration-related methods described herein. For example, the server 155 may receive briefing, evidence, hearing-related information, or other inputs from one or more remote devices, determine one or more procedural or substantive outputs based on those inputs, and provide resulting communications, rulings, decisions, or other outputs back to one or more of the remote devices. Although shown as a single server 155, the server 155 may in some embodiments be implemented using one or more computing systems operating together.

The first party device 160 may be associated with a first party to the arbitration, and the second party device 165 may be associated with a second party to the arbitration. In some embodiments, the first party device 160 and the second party device 165 may be used by the respective parties, or by representatives acting on behalf of the respective parties, to communicate with the server 155 over the network 180. By way of example, the first party device 160 and the second party device 165 may transmit information relating to the dispute to the server 155 and may receive information relating to the arbitration from the server 155. Such information may include, for example, party submissions, evidence, responses, notices, scheduling information, questions, orders, decisions, or awards. In various embodiments, the first party device 160 and/or the second party device 165 may be multiple devices associated with a given party.

The administrator device 170 may be used by an administrator to oversee operation of the arbitration system 150. In some embodiments, the administrator device 170 may communicate with the server 155 through the network 180. Additionally, as shown in FIG. 1, the administrator device 170 may optionally have a direct connection to the server 155. The direct connection may be used, for example, to set, modify, or otherwise manage settings associated with arbitrations performed by the server 155. In some embodiments, such settings may include operational parameters governing how the server 155 conducts or manages one or more portions of an arbitration.

The witness/deponent device 175 may be associated with a witness or a deponent. In some embodiments, the witness/deponent device 175 may be used to provide testimony in connection with an arbitration. For example, the witness/deponent device 175 may be used by a witness to testify during a hearing or other proceeding. Additionally or alternatively, the witness/deponent device 175 may be used by a deponent so that an audio deposition, a video deposition, or an audio-video deposition may be taken (e.g., by a party using their party device 160 and/or party device 165). Information generated using the witness/deponent device 175 may be communicated to the server 155 over the network 180 for use in connection with administration of the arbitration.

The arrangement shown in FIG. 1 is illustrative. In some embodiments, fewer, additional, or alternative devices may be used. Likewise, although the illustrated embodiment shows the first party device 160, the second party device 165, the administrator device 170, and the witness/deponent device 175 as separate devices, in some embodiments one or more functions described with respect to those devices may be carried out using other device arrangements. The configuration of FIG. 1 therefore provides one example of a distributed system in which multiple participants may communicate with the server 155 to facilitate administration of an arbitration.

Arbitration is a form of dispute resolution in which parties submit a dispute to one or more decision-makers outside of a court proceeding. In many instances, arbitration may be selected by contract before any dispute arises, although arbitration may also be agreed to after a dispute has arisen. Parties may define the scope, structure, and procedures of an arbitration in an arbitration agreement or in related procedural provisions. For example, parties may agree to binding arbitration, non-binding arbitration, expedited arbitration, document-based arbitration, remote arbitration, in-person arbitration, or hybrid procedures combining features of multiple arbitration formats.

In some circumstances, parties may further agree to rules governing how claims are presented, how responses are submitted, whether discovery is permitted, how evidence is exchanged, whether witness testimony or depositions are allowed, and whether a hearing will occur. Parties may also agree to limitations on timing, page count, number of submissions, confidentiality, selection of applicable law, selection of an arbitral forum, identity or qualifications of an arbitrator, and the form of any resulting decision or award. Accordingly, arbitration procedures may vary substantially from one dispute to another depending on party agreement, governing rules, and the nature of the dispute.

Although arbitration can provide a flexible framework for dispute resolution, administration of an arbitration may involve substantial coordination among parties, witnesses, representatives, and decision-makers. Submissions may include pleadings, briefs, documentary evidence, audiovisual materials, deposition testimony, transcripts, procedural motions, and hearing-related materials. In many cases, the information relevant to an arbitration is distributed across multiple devices, users, and data sources. As a result, systems that facilitate structured submission, review, analysis, questioning, decision generation, and communication of arbitration-related information may improve the efficiency and consistency with which arbitrations are administered.

In various embodiments, the systems, methods, and computer-readable media described herein may themselves define or implement a form of arbitration procedure to which parties may consent. For example, parties may agree by contract, stipulation, platform enrollment, arbitration clause, or post-dispute submission agreement that some or all aspects of an arbitration are to be administered using the disclosed techniques. Such consent may extend to the manner in which briefs, evidence, testimony, hearing responses, procedural requests, and other dispute-related information are submitted, analyzed, evaluated, and used to generate one or more rulings, decisions, or awards.

In various embodiments, the disclosed techniques may provide advantages in administering arbitrations, including improved efficiency in receiving and organizing submissions, improved consistency in applying authorities and procedural rules, improved ability to process multiple forms of evidence including audiovisual materials and transcripts, improved identification of factual disputes or evidentiary gaps for questioning, improved transparency through generation of reasoned written decisions with supporting citations, and improved accessibility by allowing geographically separated parties, administrators, witnesses, and deponents to participate through network-connected devices. In some embodiments, these and other features may reduce delay, reduce administrative burden, and improve the structured handling of arbitration-related information.

Conventional arbitration and dispute resolution processes can involve substantial human effort, which may contribute to delay, expense, inconsistency, and procedural inefficiency. In various circumstances, review of party submissions, evidentiary materials, procedural requests, and applicable authorities may require significant manual coordination among parties, administrators, witnesses, and decision-makers. These challenges may be amplified where disputes involve large volumes of information, multiple forms of evidence, remote participants, compressed schedules, or issues requiring consistent application of rules and authorities across a substantial record. In various instances, existing approaches may also provide limited tools for systematically organizing submissions, evaluating evidentiary inputs, identifying factual gaps, generating focused questions, or producing written decisions that clearly explain an outcome with reference to supporting authorities.

In various embodiments, a computer-based arbitration platform may be configured to receive and manage briefs, evidence, testimony, procedural submissions, and other dispute-related information from network-connected devices associated with parties, administrators, witnesses, or deponents. The platform may analyze one or more submissions using rule-based techniques, machine learning techniques, natural language processing techniques, retrieval techniques, or combinations thereof. In various embodiments, the platform may evaluate case-related information in view of rules derived from case law decisions, contractual provisions, arbitration rules, or other authorities, and may generate one or more outputs including procedural determinations, questions for a hearing, reasoned written decisions, and awards.

In various embodiments, the platform may further process multiple forms of evidence, including documents, audiovisual materials, transcripts, and derived analytical outputs, and may incorporate such information into a structured case record. The platform may identify unresolved issues, factual conflicts, or evidentiary gaps and may generate targeted questions for transmission to one or more party devices, after which responses may be received and incorporated into subsequent analysis. In various embodiments, these techniques may improve efficiency in administering arbitrations, improve consistency in processing submissions and applying relevant authorities, improve handling of diverse evidentiary formats, and improve transparency through generation of written decisions that include rationales and supporting citations. In various embodiments, use of network-connected devices may also improve accessibility and participation for geographically separated parties and other participants while reducing administrative burden associated with conventional arbitration procedures.

In various embodiments, the systems and methods described herein may employ one or more algorithms for processing dispute-related information. As used herein, an algorithm may refer to a defined sequence of computational operations configured to receive one or more inputs, process the one or more inputs according to one or more rules or learned parameters, and generate one or more outputs. In various embodiments, inputs to an algorithm may include features, which may correspond to measurable or machine-detectable characteristics of input data, and outputs of the algorithm may include labels, classifications, scores, rankings, generated text, or other machine-produced results.

In various embodiments, the systems and methods described herein may employ one or more deep neural networks. A deep neural network may include an input layer, an output layer, and a plurality of intermediate layers positioned therebetween. The intermediate layers may be referred to as hidden layers and may include multiple interconnected computational nodes. Each computational node may be configured to receive data from one or more prior nodes, apply a transformation to the received data, and provide transformed data to one or more subsequent nodes. In various embodiments, the arrangement of layers, the number of nodes within a given layer, the connections between layers, and the types of transformations used by the deep neural network may be defined by a network architecture. Different network architectures may be selected based on the type of input data to be processed and the type of output to be generated.

In various embodiments, the systems and methods described herein may employ a large language model. A large language model may comprise a deep neural network configured to process and generate natural-language text. In various embodiments, the large language model may employ a transformer architecture. A transformer architecture may include one or more self-attention mechanisms configured to evaluate relationships among multiple portions of an input sequence. By operation of the self-attention mechanisms, the large language model may identify contextual relationships among words, phrases, clauses, or other textual units appearing at different positions within the input sequence. In this manner, the large language model may process text while accounting for dependencies extending across a comparatively large span of the text.

In various embodiments, textual data provided to a large language model may be tokenized into a sequence of discrete units. The discrete units may be referred to as tokens and may correspond to words, subwords, characters, punctuation, symbols, or other encoded textual elements. In various embodiments, the tokens may be converted into embeddings, where an embedding comprises a numerical representation of a token in a vector space. The embeddings may then be provided to the large language model as machine-processable input. During operation, the large language model may process a sequence of tokens and generate a prediction corresponding to a subsequent token, a sequence of subsequent tokens, or another output derived from the sequence of tokens. Accordingly, in various embodiments, the large language model may be configured to generate text based on learned relationships among tokens represented in the training data.

In various embodiments, the large language model may be used alone or in combination with one or more additional machine-learning models, rules-based modules, retrieval modules, or verification modules. For example, a large language model may receive tokenized and embedded text derived from briefs, evidence, testimony, procedural submissions, or authority materials, and may generate one or more outputs including summaries, classifications, questions, analytical passages, or written decisions. In various embodiments, the large language model may further operate in conjunction with one or more retrieval processes configured to obtain related source materials, one or more ranking processes configured to prioritize source materials, or one or more validation processes configured to assess whether a generated output satisfies a defined criterion. In this manner, deep neural networks and large language models may be incorporated into a broader computing architecture configured to process, analyze, and generate outputs based on text and other case-related information.

In various embodiments, an arbitral award or one or more portions thereof may be generated using probabilistic output techniques implemented by a deep neural network, a large language model, or a combination thereof. For example, a decision-oriented deep neural network may receive features derived from briefs, evidentiary materials, case authorities, damages-related information, procedural history, or other dispute-related data, and may process such features through multiple computational layers to identify patterns and correlations associated with one or more potential outcomes. In various embodiments, the output of the deep neural network may correspond to a label representing a discrete arbitration result, such as an award in favor of a claimant, an award in favor of a respondent, a partial award, a dismissal, or another defined outcome category.

In various embodiments, where a large language model is used, the model may generate output by predicting a subsequent token or sequence of tokens based on previously processed tokens and learned relationships among token sequences. Through iterative token prediction, the large language model may generate extended text corresponding to an analysis, a rationale, a procedural determination, or an arbitral award. Accordingly, in various embodiments, dispute-related outputs may be generated through probabilistic processing of input data, whether in the form of outcome classification by a deep neural network, token-sequence generation by a large language model, or coordinated operation of both.

In various embodiments, the systems and methods described herein may include a computing architecture and associated protocols configured to apply machine learning, human reinforcement, and large language model processing to arbitration-related decision generation. In various embodiments, the computing architecture may be configured both to implement a machine-based decision workflow and to process one or more example dispute scenarios so as to evaluate operation of the workflow under controlled conditions. Such scenarios may be defined using one or more metadata variables, including a jurisdiction variable and a dispute-topic variable. In various embodiments, the jurisdiction variable may correspond to a state or other legal forum, and the dispute-topic variable may correspond to a substantive dispute category.

In various embodiments, operation of the system may include multiple stages. In a first stage, a set of user-facing procedures may be defined for interaction with the system, including procedures by which party devices submit briefs, evidence, and other dispute-related data for processing. In a second stage, one or more hypothetical or simulated dispute scenarios may be generated for selected jurisdictions and dispute topics using the disclosed computing architecture and processing methodology. In a third stage, the system may process the submitted or simulated dispute data and generate one or more outputs, including opinions, determinations, analyses, or other dispute-related decisions. In various embodiments, the system may be configured to operate in a fully briefed ex post adjudication setting in which multiple party submissions are received and processed. In some embodiments, the same or similar processing principles may be applied to an ex ante query setting in which a first submission is received from a human user, a second submission is generated by an artificial intelligence agent, and one or more facts set forth in the submission are provisionally treated as true for purposes of generating a responsive output.

In various embodiments, output generated by the system may be evaluated according to one or more quality metrics. Such quality metrics may include hallucination, completeness, groundedness, or other measures indicative of output reliability or analytical sufficiency. In various embodiments, one or more of the quality metrics may be encoded into a machine-readable format, including a one-hot encoded representation, and stored in a structured data file, such as a comma-separated values file, for later analysis, benchmarking, or model comparison.

In various embodiments, one or more generated outputs may be selected from different dispute-topic distributions for qualitative review. For example, selected outputs may correspond to insurance disputes, commercial disputes, contractual disputes, or other categories of legal or quasi-legal controversy. In various embodiments, such outputs may be reviewed and graded to assess how the generated analyses correspond to expected dispute-resolution behavior and to evaluate the relevance of the generated analyses to arbitration-related decision-making.

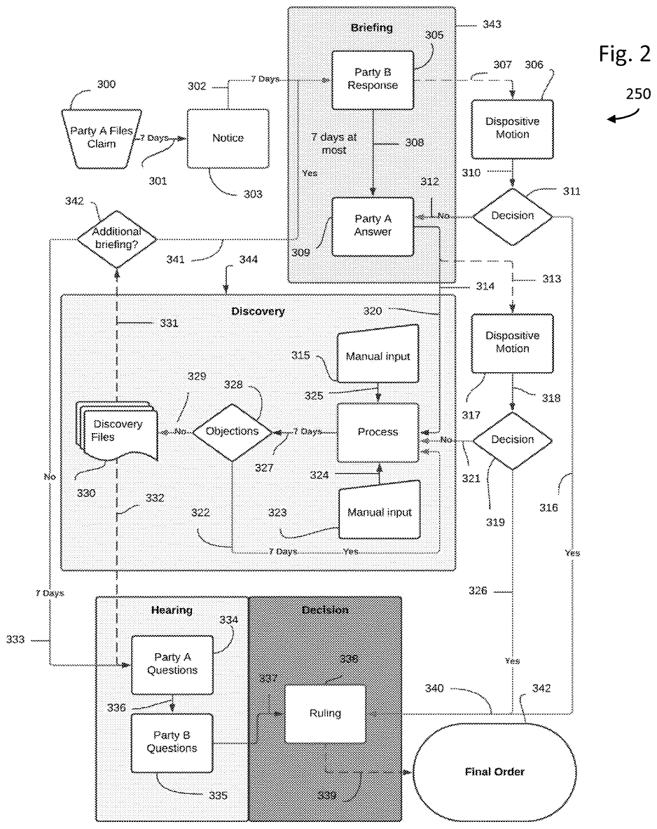

FIG. 2 shows a method 250 for using the various embodiments described herein for performing an arbitration. In various embodiments, users may be formally invited to a portal only after a Party files a claim, such Party being designated as “Party A” (300). In various embodiments, after the claim is filed, the system may have seven days (7) to serve valid, legal notifications to each party (301), wherein the valid legal notification includes the substantive complaint from Party A. In various embodiments, each party may then have seven (7) days to confirm notification (302-303). Once notification is confirmed, the parties may be advanced to a second stage corresponding to briefing (343).

In various embodiments, during briefing, a deadline for a response brief submitted by Party B may be seven (7) days (305-308). In various embodiments, Party A may then have seven (7) days to file an answer (308-309). During this period, either Party may file a dispositive motion (306-307, 313, 317). In various embodiments, the system may determine the motion (310-312, 316, 318-319, 321). If the motion is dispositive, a ruling may be issued and a final order authorized (338-339, 342). If the motion is not dispositive, a ruling may still be issued, and the Parties may be returned to briefing (312, 321). In various embodiments, after briefing, the Parties may be advanced to discovery (344).

In various embodiments, during Discovery, both Parties may be ordered to submit evidence (315, 323, 324-325). In various embodiments, after Discovery is processed, the Parties may have seven (7) days to file objections and request additional evidence (328). If the system agrees with a Party's objection or request for additional information, the Parties may have seven (7) days to resubmit relevant Discovery to be processed (322). In various embodiments, the Discovery may then be processed again. If there are objections and the system agrees, the process may begin again (322). If there are no objections, the system may determine whether to order additional briefing, in which case the process may begin again (330-331, 341-342).

In various embodiments, if the system determines that no additional briefing is necessitated, the system may order a Hearing (333). During the Hearing, both Parties may be queried substantially simultaneously with questions generated by the system (334-336). In various embodiments, both Parties may be provided an opportunity to review responses. After the Hearing is concluded, the system may issue a ruling within three (3) days (337-339). Either as part of, or separate from, the ruling, depending on the case, the system may also issue a Final Order (342), wherein the Final Order contains the specific award.

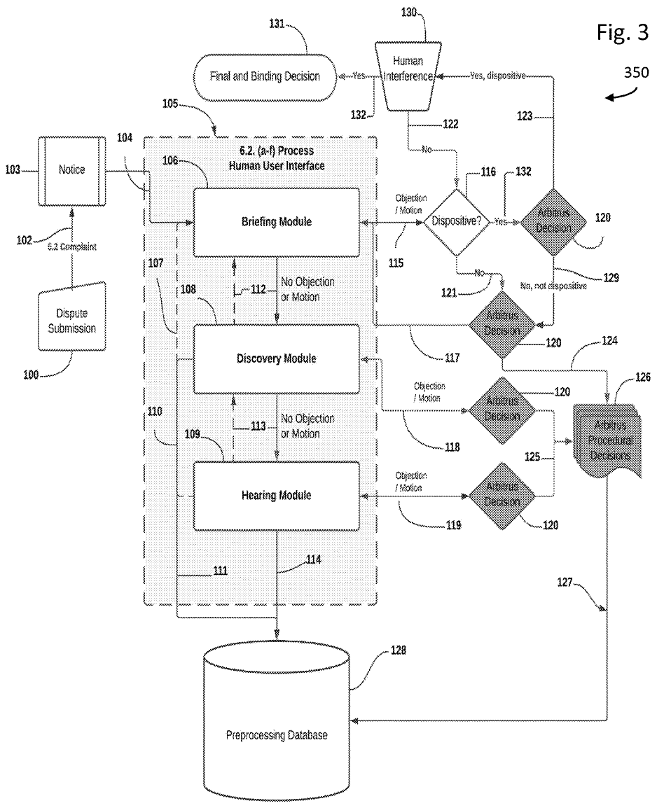

In various embodiments, the disclosed system may comprise an end-to-end process involving human users and one or more artificial intelligence systems, wherein the artificial intelligence systems may be supplemented by human review and reinforcement. In various embodiments, from a backend perspective, human interaction with the system, predominantly by two adversarial parties, may occur through four primary modules illustrated in FIG. 3, with corresponding module units represented by a 100 series. In various embodiments, after a party files a dispute submission (100), both parties may be summoned to a notice module through electronic communication, predominantly email (102-103). In various embodiments, the human users may then be provided access to a Graphical User Interface (105).

In various embodiments, unless there is an objection (115), both parties may be prompted to provide briefs within a given timeframe (104-106). If there is an objection, the system may determine the result (116). If the system determines that the motion is dispositive (116, 132) in nature, the system may determine on the merits whether the case should be disposed (120). If the motion is not dispositive, a decision may be issued and reported in a Procedural Decisions module (117, 120, 124, 126). If the case should be dispositively ruled on, a human may review and confirm the output (130). If the human agrees that the case should be dispositively ruled on, a final and binding ruling may be issued to the parties (131-132). Otherwise, the case may be returned to the system for further processing (122).

In various embodiments, after briefs are submitted, the parties may be advanced to a discovery module for additional information gathering (108). During this phase, the parties may file objections to discovery on reasonable grounds (118, 113). In various embodiments, a recording of the ruling may be returned to the Procedural Decisions module and reported to the parties (118, 125-126). In various embodiments, it is during this phase that depositions involving cross examination may occur and be uploaded (108).

In various embodiments, the parties may then be advanced to a hearing module to present their case and answer questions queried by the system, wherein the hearing is conducted in writing and does not permit cross examination (119, 114, 109). If a motion is made or submitted during the hearing, the system may render a decision and report the decision into the Procedural Decisions module (119, 120, 125, 126). In various embodiments, the process may be iterative (110, 107, 104, 111), such that the system may determine that the parties should submit new briefs if discovery or the hearing warrants additional briefing. If the relevant human information has been sufficiently gathered, the data may be piped into a database (110, 107, 104, 111, 114, 127). In various embodiments, the system may then transition to a subsequent phase of artificial intelligence decision making (128).

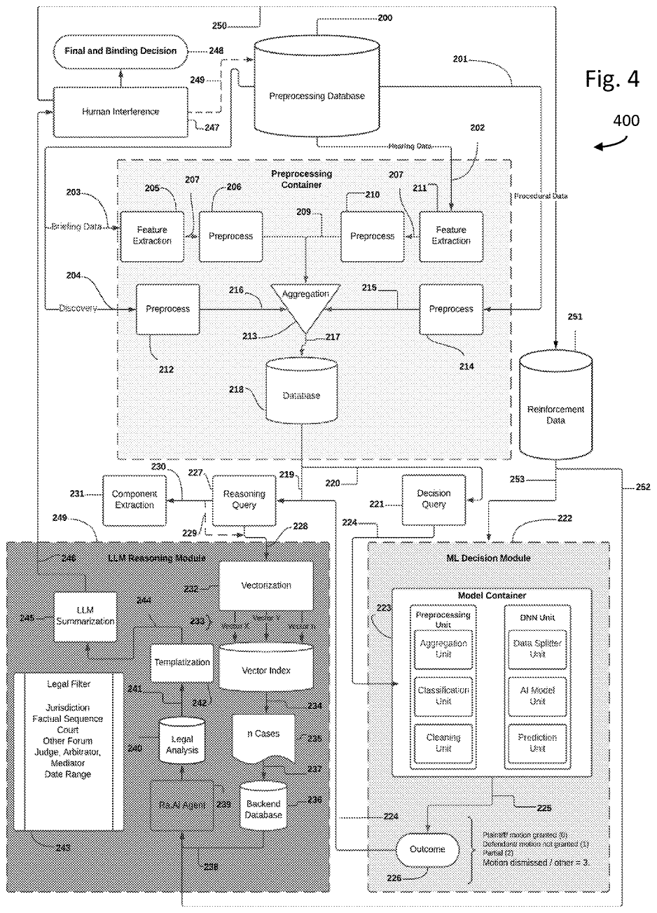

In various embodiments, after human interaction is finalized, a first stage of artificial intelligence decision making may include preprocessing information such that the information is available for use in both large language model and machine learning contexts. In various embodiments, this process is illustrated in FIG. 4 in a 200 series. On the machine learning side, information may be feature extracted employing a proprietary methodology (202, 211, 201, 214, 204, 212, 204, 205) that transforms raw text data into features that can be applied to a voting ensemble. On the large language model side, information between each step may be processed and checked for prompt hacking or other malicious data, and may then be merged into a single file that summarizes the positions, data, evidence, and responses of both parties.

In various embodiments, data aggregated from the human interface may be piped into a preprocessing container (201, 202, 203, 204). In various embodiments, the preprocessing container may merge the data (209, 213, 215-216) into a single database (217-218), where transformed raw text data may be sent to a machine learning Decision Module or to a large language model Reasoning Module (219, 220, 221).

In various embodiments, a subsequent stage of decision making may include determining an overall ruling of the case. In various embodiments, data may be piped through a decision query into several classification models (221, 224, 223), and the classification models may predict and encode a multi-categorical outcome, including Ruling for Plaintiff=0, Ruling for Defendant=1, A partial outcome=2, and dismissal of the case or motion, or other result=3 (223, 225, 226). In various embodiments, each classification model may vote on an outcome, with each vote weighted based on the accuracy of the respective classification model (223, 225-226). The result having the highest probability may be passed back into the reasoning query to be summarized as the decision based on the presented facts (224).

In various embodiments, a further stage of decision making may include generating an explanation of the decision in human terms (249). In various embodiments, user legal queries may first be vectorized through various methodologies (228-229, 232) and reported in a Vector Index (233). In various embodiments, cases may be systematically compared using two comparison methodologies. In a first methodology, a large language model may process a query in segments no larger than a context window of the large language model and may identify key phrases, legal terminology, and events within the query. In various embodiments, these identified data points may be designated as topics. The extracted components may then be vectorized. In various embodiments, one or more natural language processing models may embed semantic information as a vector comprising a series of floating-point numbers. Although such vectors may lack independent human-readable meaning, the vectors may be compared to other vectors generated by the same model to evaluate semantic similarity, contextual similarity, or both. In various embodiments, in a second methodology, a large language model may process the query in segments no larger than the context window and may extract one or more relevant legal rules from the context of user briefs. In various embodiments, the extracted legal rules may be compared to legal rules stored in a database, including a database of Fortuna Arbitration, wherein the legal rules in the database have been extracted from cases using a proprietary methodology. In various embodiments, the first methodology and the second methodology may be used together to improve groundedness of the generated output.

In various embodiments, the vectors may be compared to other vectors in a Vector Index using cosine similarity (233, 234). In various embodiments, the disclosed system may employ a preprocessing methodology configured to extract key legal and factual concepts prior to retrieval, such that retrieval is performed based on the extracted concepts rather than on raw legal text. In various embodiments, such key concepts may correspond to legal rules, factual issues, or other semantically meaningful units derived from the underlying materials. In some legal research contexts, these key concepts or rules may correspond to headnotes. In various embodiments, the most similar vectors may be returned (234-237), and the returned vectors may then be checked using a further, different transformer model to verify similarity (234).

In various embodiments, the process may retrieve full case opinions, according to a specified number n, related to the returned vectors. In various embodiments, a backend database may access a case database and may pass in all opinion identifiers returned from the Vector Index search. The full case data may then be transferred to a backend generator for drafting. In various embodiments, a separate large language model may be used to check similarity again and to pull the full opinion text of cases that are most similar from a first-party case database (235-237). In various embodiments, those cases may then be provided to one or more large language models together with the relevant client data.

In various embodiments, the data may next be filtered through an argument iteration engine, illustrated in FIG. 4 by several proprietary filters (239-241), wherein a combination of deep-learning networks and human interaction may be trained to evaluate suggested responsive communication based on a variety of factors for likelihood of success (239-241). In various embodiments, machine learning models for evolutionary iteration may be employed to optimize performance. In some embodiments, because the disclosed system may produce results ex ante the reasoning, evolutionary iteration may be omitted. In various embodiments, including early prototype embodiments, the argument iteration engine may include a prediction component configured to generate one or more predictive outcomes for the suggested responsive communications. Based on these predictive outcomes, the software platform may generate output data as determined by the user or guided by the type of situation associated with each legal query. In various embodiments, subject to further metadata, the models may be based on courts, forums, judges, arbitrators, mediators, and date ranges. In various embodiments, non-metadata inputs, including rule statements, may also be included.

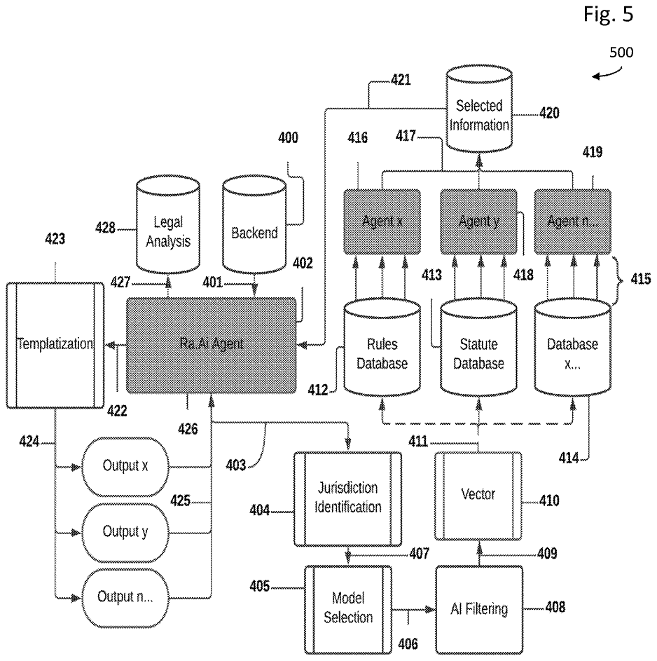

In various embodiments, an iteration component of the argument iteration engine may occur within an agentic solution illustrated in FIG. 5 and, for practical purposes, represented by (239). In various embodiments, opinions returned by the agentic solution may include a number of characters that exceeds a context window of a large language model used for drafting suggested responsive communications after tokenization. Accordingly, in various embodiments, the opinions may first be summarized by a separate large language model, and summaries of the opinions and associated legal research may then be provided to primary prompts for generation of suggested responsive communications (242).

In various embodiments, the generational prompts may be tailored to follow an IRAC or CRUPAC legal model for creation of legal writings, and may apply rules extracted from the opinions to client issues in the legal queries (245-246). In various embodiments, as a quality control measure for onboarding new clients, output data may be reviewed by a human (247) before being issued as a final and binding opinion to the parties (248). In various embodiments, human-reviewed briefs may be graded for sufficiency and returned to a reinforcement training database, where the data may be used to train future machine learning decision models and agentic components (250-253). In various embodiments, the output data may include different outcomes in the form of different types of legal writing, including motion rulings, final and binding opinions, and other responsive legal communications.

In various embodiments, an agentic solution identified as Ra.ai may be configured as a supervisory component for reducing or eliminating hallucinations within the processing workflow. In various embodiments, the Ra.ai system may include multiple calls to one or more large language models, wherein the one or more large language models evaluate and police generated results. In various embodiments, the Ra.ai agentic solution may be arranged hierarchically relative to other agents in the system, including source agents (416-419), front-end templatization and return components (423-425), and evaluation components configured to determine whether templatization may pass to the frontend (427-428) or instead be reiterated (403). In various embodiments, the number of calls made within the Ra.ai system may vary, and correspondingly the number of agentic components participating in a given workflow may also vary.

In various embodiments, the Ra.ai agentic solution may operate as an orchestration or governing layer over the other agents, without necessarily requiring that the Ra.ai agentic solution correspond to the largest or most sophisticated model in every implementation. In some embodiments, depending on the particular call being made, the Ra.ai agentic solution may correspond to the largest or most sophisticated model used for that call.

In various embodiments, Ra.ai may comprise an agentic solution configured to address hallucination within the disclosed processing workflow, as illustrated in FIG. 5. In various embodiments, and as further reflected by the preprocessing and retrieval workflow, vectors may be passed into a backend database (236, 400). In various embodiments, the backend may include a finite number of vector-relevant cases (235). The backend database may then pass the data into Ra.ai (400-402).

In various embodiments, Ra.ai may determine a relevant jurisdiction according to a predetermined process, including a prompted identification of one jurisdiction from among a set of U.S. states (404-404). In various embodiments, the jurisdiction identification process may then select a large language model (407, 405), and the selected large language model may filter cases exclusively related to the identified jurisdiction (406, 408) or according to a preferred filter, such as only a rule or only a statute.

In various embodiments, thereafter, the vector may be passed into case data, wherein the database to which the vector is passed may be controlled by artificial intelligence filtering (411-414). In various embodiments, the cases returned in the backend database may be sorted by category into several different databases (412-414). Each of these databases may then pass final related sources, which may be numerous and may normally include five to ten sources (415-416, 418-419). In various embodiments, each artificial intelligence agent, using a model defined by (405), may rank the sources before passing the highest-ranked sources, including up to three sources, although that number may be varied, into a selected information database (417, 420).

In various embodiments, the selected information database may then be passed back into Ra.ai, and Ra.ai may select the best sources (420-421). Ra.ai may then pass the information into various templates, including templates corresponding to IRAC elements such as issue and rule (402, 422-423), and the templates may employ various large language models to produce various outputs (424). In various embodiments, Ra.ai may determine whether the output is sufficient (425, 402). If the output is sufficient, the output may be returned to a legal analysis database (427-428). In various embodiments, the legal analysis database may store analysis for use in a large language model summarization stage in which a final opinion is written (240-242, 244).

In various embodiments, if Ra.ai determines that the outputs are not sufficiently related to the input, Ra.ai may iteratively return the outputs to the analysis process (403-421). In various embodiments, this iteration process may enable Ra.ai to assign micro-tasks to different agents, including tasks relating to selection of relevant cases (416-419) and preparation of analysis (422-425). In various embodiments, Ra.ai may thereby access multiple custom APIs and other tools to retrieve and select sources relevant to the dispute.

FIG. 3 therefore illustrates an example server-side workflow 350 for collecting dispute-related inputs from distributed client devices and converting those inputs into a machine-processable case record for subsequent automated adjudication. In various embodiments, a server 155 receives an initial dispute submission at a filing stage 100 and, responsive to the submission, electronically generates and transmits notices 102, 103 to respective party devices over a network. The server 155 may further provision or enable access to a graphical user interface at stage 105, thereby causing the party devices to enter a controlled portal workflow through which subsequent submissions are received in a structured format.

In various embodiments, the workflow 350 includes a briefing stage 104-106 in which the server 155 receives party briefs and associated procedural submissions, time-stamps those submissions, and stores them in association with a case identifier. Where an objection or motion is submitted at stage 115, the server 155 may route the submission to a procedural-decision path 116 and determine whether the objection or motion is dispositive. If the server 155 determines that a dispositive condition is present, the server 155 may generate a dispositive output for human confirmation at stage 130 before issuing a final ruling at stages 131-132. If the server 155 determines that the motion is non-dispositive, the server 155 may generate a procedural decision and record that decision in a procedural-decision module at stages 117, 120, 124, and 126, after which the workflow may return to a non-dispositive processing path.

In various embodiments, after briefing is received, the server 155 advances the matter to a discovery stage 108 in which additional evidentiary information is collected from one or more party devices or witness/deponent devices. The server 155 may receive uploaded documents, deposition recordings, transcripts, or other evidentiary content and associate the received content with the corresponding case record. If a party submits a discovery objection or request for additional information at stage 118, the server 155 may generate and record a ruling and return that ruling to the procedural-decision module at stages 125-126. In various embodiments, deposition content involving cross-examination is uploaded during the discovery stage and stored as part of the case data later used by backend processing modules.

In various embodiments, the workflow 350 further includes a hearing stage 109, 114, 119 in which the server 155 generates written questions for transmission to party devices and receives written responses from those devices. The hearing stage may be iterative such that the server 155, based on information received during discovery or during the hearing itself, returns the matter to one or more prior stages 110, 107, 104, 111 for additional briefing, supplementation, or clarification. When the server 155 determines that sufficient human-generated information has been collected, the server 155 aggregates the case-related data and pipes the data into a database 127 for subsequent backend processing at stage 128. Accordingly, FIG. 2 may be understood as illustrating a networked intake and procedural-control architecture in which distributed user inputs are normalized into a server-managed case record through a staged and iterative electronic workflow.

FIG. 4 illustrates an example backend processing workflow 400 by which the server 155 converts the case record generated through the FIG. 3 workflow into machine-usable inputs for automated outcome determination and written-decision generation. In various embodiments, aggregated case data is first routed into a preprocessing container 201, 202, 203, 204. The preprocessing container may merge party briefs, evidentiary data, hearing responses, and other case materials into a unified data structure or merged file at stages 209, 213, 215-216, and may store the merged output in one or more databases 217-218. In various embodiments, the preprocessing container performs data checking between stages, including detection of prompt-hacking attempts, malicious payloads, or other malformed content before such content is forwarded to downstream reasoning modules.

In various embodiments, the preprocessing container applies a feature-extraction process to raw textual data so as to transform the textual data into feature representations usable by one or more machine learning models. The transformed data may then be selectively routed to an ML decision module or to an LLM reasoning module at stages 219, 220, 221. Thus, rather than merely storing party submissions as unstructured text, the server 155 performs a data-transformation operation in which raw case text is converted into a form adapted for subsequent computational classification and reasoning.

In various embodiments, the ML decision module receives a decision query derived from the transformed case data and routes the query to multiple classification models at stages 221, 223, 224. The respective classification models may predict encoded categorical outcomes, such as a claimant-favoring result, a respondent-favoring result, a partial outcome, a dismissal, or another defined result category at stages 223, 225, 226. The server 155 may then aggregate outputs of the classification models using a voting ensemble in which individual model votes are weighted based on model accuracy. The ensemble output having a highest probability may be returned to a reasoning path as a machine-selected outcome hypothesis to be explained in natural-language form. In this manner, the backend architecture performs a computer-implemented multiclass classification operation on transformed case data before generation of explanatory text.

In various embodiments, the reasoning path of FIG. 4 performs retrieval and verification operations to ground the written decision in authority data stored separately from the case record. A legal query derived from the case data may be vectorized at stages 228, 229, 232 and stored or referenced in a vector index 233. The server 155 may compare the query vector to stored vectors representing legal authorities using cosine similarity, retrieve the most similar vectors, and then submit the retrieved results to an additional transformer-based verification stage 234 configured to verify similarity. In various embodiments, a separate large language model further checks similarity and causes the server 155 to retrieve full opinion text for the most similar cases from a case database at stages 235-237. The retrieved opinion text is then supplied together with the client-specific case data to one or more large language models for generation of explanatory output. Accordingly, FIG. 4 supports a multi-stage retrieval pipeline that includes vectorization, indexed similarity comparison, secondary similarity verification, and full-text authority retrieval before generation of a written decision.

In various embodiments, the server 155 further routes retrieved case material and case-specific data through an argument iteration engine 239-241. The argument iteration engine may apply one or more proprietary filters to evaluate candidate responsive communications according to one or more success-related criteria. Where returned authority data exceeds an available context window, the server 155 may invoke an additional summarization model 242 to compress or summarize retrieved opinions before providing the summarized content to a primary generation prompt. In various embodiments, the primary generation prompt is templated according to a predefined analytical format, such as an issue-rule-application-conclusion format, and applies rules extracted from retrieved opinions to client-specific issues at stages 245-246. By summarizing retrieved source material before main-text generation, the server 155 performs a further technical reduction of token load and adapts retrieved source content to model context-window constraints.

In various embodiments, a quality-control stage 247 may route generated output for human review before issuance of a final opinion 248. Review results may be stored in a reinforcement training database 250-253 and used to train later decision models or source-selection agents. Thus, FIG. 4 also illustrates a feedback architecture in which post-generation review data is persisted and used to improve subsequent model operation.

FIG. 5 illustrates an example authority-processing and rule-generation workflow in which legal authorities are transformed into indexed representations and rule-linked source data for later use by the backend reasoning system. In various embodiments, vectors corresponding to legal queries or authority-derived content are passed into a backend database 236, 400 that stores a finite collection of vector-relevant cases 235. The backend database forwards the vector input into an agentic control layer 400-402 that first determines a relevant jurisdiction 404. Based on the determined jurisdiction, the control layer selects a model 405, 407 and filters candidate source materials to jurisdiction-specific authorities at stages 406, 408. In various embodiments, the filtering may additionally be constrained by source type, such as rules, statutes, or other categories of legal material.

In various embodiments, after jurisdiction-specific filtering, the vector is passed into one or more case databases 411-414. Returned case data is sorted into multiple category-specific databases 412-414, thereby separating authorities according to category before further ranking. Each category-specific database may return multiple related sources 415-416, 418-419 to one or more AI agents operating under the selected model definition. The AI agents rank the candidate sources and pass higher-ranked sources, such as a top subset, to a selected information database 420. The selected information database is then returned to the control layer, which chooses among the ranked source sets at stage 421. In this manner, FIG. 5 supports a hierarchical authority-selection architecture in which authority data is filtered by jurisdiction, distributed across category-specific stores, ranked by multiple agents, and consolidated into a selected information store for later reasoning.

In various embodiments, the selected authority information is then inserted into one or more analytical templates 422-423, such as issue, rule, application, or conclusion templates, and processed by one or more large language models to generate candidate analyses 424. A sufficiency check 425 is then performed on the generated output. If the generated output satisfies a sufficiency criterion, the output is stored in a legal analysis database 427-428 for later use in decision drafting. If the generated output fails the sufficiency criterion, the system iteratively returns to one or more prior stages 403-421 to perform additional source selection, filtering, ranking, or template-based analysis. Accordingly, FIG. 5 supports an iterative, database-backed authority-processing workflow in which generated analysis is not accepted unless it satisfies a defined adequacy condition.

The embodiments and FIGS. 2-5 herein therefore illustrate an example agentic control workflow for reducing unsupported or insufficiently related authority outputs by decomposing authority-selection and analysis into multiple machine-executed subtasks. In various embodiments, an agentic controller receives source candidates from the backend database and determines a jurisdiction-specific processing path. The agentic controller then selects one or more models and distributes micro-tasks among multiple AI agents, including source-selection micro-tasks, ranking micro-tasks, and analysis-generation micro-tasks. Different agents may access different databases, APIs, or retrieval tools and may return ranked results to a shared selected-information database. The agentic controller evaluates whether the returned analyses are sufficiently related to the input query and, if not, recursively reissues one or more micro-tasks to refine source selection or revise analytical output.

Various embodiments herein therefore operate as more than a single-pass generation process. Instead, the workflow performs iterative source retrieval, source ranking, template-based analysis generation, and sufficiency verification, with intermediate results being stored in and retrieved from dedicated backend databases. Such a configuration may reduce reliance on a single generative pass by causing the server 155 to perform multiple distinct machine operations across multiple data stores before issuance of an output. In various embodiments, the result is a server-controlled processing pipeline in which distributed party inputs are transformed into structured case data, structured case data is transformed into feature and vector representations, retrieved authorities are verified and ranked through multiple stages, and candidate analyses are iteratively refined before generation and transmission of a written decision.

In various embodiments, data for the disclosed systems, methods, and computer-readable media may be collected and categorized according to a multi-stage procedure configured to generate adversarial briefing data, generate corresponding opinion data, and evaluate the resulting outputs according to one or more quality metrics. In one example embodiment, the data collection procedure may include generating briefs for opposing parties, generating opinions using a backend decision process, and applying a standardized grading procedure to assess validity of the generated outputs.

In various embodiments, to address a limited availability of real-world source data, the system may employ a large-language-model-driven synthetic data paradigm to create scenarios, match facts to the scenarios, and generate responsive situations. In some embodiments, a brief may correspond to a single party's arguments on the merits and procedure for a given case. Each brief may include a summary section, a fact section, substantive arguments, and a conclusion. In some embodiments, each brief may be configured as a dispositive brief such that the brief includes a sufficient set of legal arguments and facts for the backend system to render an opinion without requiring iterative briefing. In this manner, the generated brief data may reduce dependence on additional rounds of party submissions that might otherwise occur when relevant facts or arguments are omitted. In various embodiments, the generated briefs may include invalid, weak, or hallucinated legal arguments to reflect arguments that may be presented by human advocates in practice. Accordingly, in some embodiments, the generated briefs need not be pre-screened for hallucination, groundedness, or correctness before use in downstream processing. In various embodiments, briefs may be generated for both opposing parties and reported to one or more human researchers.

In various embodiments, opinion data may be generated by placing matched briefs corresponding to opposing parties for a given case into the backend process of the disclosed system. The backend process may generate an opinion responsive to the matched briefs, and the generated opinion may then be reported to a human researcher. In some embodiments, the system may also generate descriptive metadata associated with the opinion, including jurisdiction data and dispute-topic data. The human researcher may record the descriptive metadata and may verify that the metadata accurately corresponds to the generated opinion. In various embodiments, the human researcher may further categorize the outcome by identifying a prevailing party, including categorization of the prevailing party as a claimant or a respondent.

In various embodiments, generated opinion data may be graded according to a plurality of evaluation metrics, including hallucination, completeness, and groundedness. In some embodiments, hallucination may be recorded when an opinion contains a fact, case, or concept that does not exist. Such hallucination may range from an incorrect citation detail to an entirely fabricated legal precedent. In some embodiments, completeness may correspond to whether the ruling answers the question or questions presented by the briefed query such that the issue in controversy is resolved. In various embodiments, groundedness may correspond to whether the ruling includes legal authority that is properly cited, factually relevant, and responsive to the issue in controversy.

In various embodiments, the evaluation metrics may be encoded into structured variables for storage and later analysis. For example, hallucination may be one-hot encoded such that a first value indicates a non-hallucinated output and a second value indicates a hallucinated output. Completeness may be one-hot encoded such that a first value indicates an accurate or complete output and a second value indicates an inaccurate or incomplete output. Groundedness may be one-hot encoded such that a first value indicates that law is cited and relevant and a second value indicates that no law is cited or that cited law is irrelevant. Because one or more of these variables may include a subjective component, each grade may be reviewed for accuracy before final storage. Once confirmed, the grade data may be recorded and stored in a structured data file, including, for example, a comma-separated value file.

In various embodiments, a subset of collected cases may be selected for qualitative review. In one example embodiment, a smaller set of cases may be chosen from a larger case set based on diversity of jurisdictions and dispute topics. For each selected case, once the briefs of the opposing parties are obtained, the system may generate a summary of each brief. In some embodiments, the summary may include a first sentence explaining contextual background of the brief and a second sentence explaining the brief's legal argument. The generated summary may then be checked against the underlying brief for accuracy and may be reported together with associated metadata. In this manner, the disclosed systems, methods, and computer-readable media may collect, categorize, validate, and store briefing data, opinion data, grading data, and qualitative-review data for use in evaluation, training, or subsequent decision-making workflows.

Example scenarios are shown below in the following table.

TABLE 1
Selected Scenarios

| Case ID | Jurisdiction | Topic | Claimant Argument | Respondent Argument |
|---|---|---|---|---|
| 4 | Illinois | Executive | The brief addresses an | The brief addresses a dispute in |
| | | Contract | employment dispute where the | which Summit Dynamics |
| | | Dispute | claimant, Victoria Green, alleges | Corporation argues that it lawfully |
| | | | that Summit Dynamics | terminated Victoria Green for |
| | | | Corporation breached an | cause, citing gross mismanagement, |
| | | | executive employment contract | budgetary misconduct, and breaches |
| | | | by failing to provide severance | of fiduciary duty, thereby rendering |
| | | | and equity compensation upon | her claims for severance and equity |
| | | | her termination without cause, in | compensation invalid under the |
| | | | violation of Illinois law. | employment contract and Illinois |
| | | | Summit Dynamics materially | law. |
| | | | breached its clear and enforceable | Summit Dynamics asserts that |
| | | | contract with Green by not paying | Green's termination was justified as |
| | | | $200,000 in severance and | “for cause” under the contract due |
| | | | $150,000 in equity compensation | to her documented mismanagement |
| | | | following her termination, which | and fiduciary breaches, precluding |
| | | | was for “restructuring” and does | her entitlement to severance, equity |
| | | | not qualify as “cause” under | compensation, or attorney's fees, |
| | | | Illinois law or the contract's | and requests dismissal of her |
| | | | terms. | claims. |
| 17 | Louisiana | Payment in | The brief concerns a payment | The brief addresses a construction |
| | | Construction | dispute in which Crescent Bay | contract dispute in which Riverfront |
| | | | Builders seeks to recover | Commercial Development Group |
| | | | $180,000 in unpaid amounts, | argues that Crescent Bay Builders |
| | | | interest, and attorney's fees from | failed to meet contractual |
| | | | Riverfront Commercial | obligations by delivering delayed |
| | | | Development Group for labor, | and substandard work, improperly |
| | | | materials, and change orders | charging for unapproved change |
| | | | completed under a construction | orders, and causing financial harm |
| | | | contract for a commercial | to Riverfront. |
| | | | building project in Baton Rouge, | Riverfront contends that Crescent |
| | | | Louisiana. | Bay breached the contract by |
| | | | Crescent Bay Builders asserts that | delivering deficient and delayed |
| | | | Riverfront breached the | work, justifying the withholding of |
| | | | construction contract by failing to | payments and offsetting costs for |
| | | | pay the outstanding $180,000 for | remediation, and asserts that |
| | | | completed and approved work, | Crescent Bay's claims for additional |
| | | | and argues that Crescent Bay is | compensation lack merit due to |
| | | | entitled to full payment, interest, | unapproved charges and failure to |
| | | | and attorney's fees under the | comply with contract terms. |
| | | | contract and Louisiana law. | |
| 24 | Oregon | Insurance | The brief addresses an insurance | The brief addresses an insurance |
| | | Coverage | dispute in which Harper | dispute in which NorthStar |
| | | Disputes | Industries seeks compensation | Insurance argues that its denial of |
| | | | from NorthStar Insurance for $1.2 | Harper Industries' claim for fire- |
| | | | million in damages resulting from | related damages was justified under |
| | | | a fire at its facility, alleging that | the policy exclusions for inadequate |
| | | | NorthStar wrongfully denied | maintenance and wear and tear, and |
| | | | coverage based on inapplicable | asserts that Harper's demands for |
| | | | exclusions and acted in bad faith | damages and attorney's fees lack |
| | | | under Oregon law. | contractual or legal support. |
| | | | Harper Industries argues that | NorthStar contends that Harper's |
| | | | NorthStar breached its contractual | claim is barred by the policy |
| | | | obligations by denying coverage | exclusions for inadequate |
| | | | for fire-related losses, relying on | maintenance and wear and tear, and |
| | | | exclusions that do not apply to | argues that Harper is not entitled to |
| | | | the accidental electrical fire, and | consequential damages or attorney's |
| | | | contends that Harper is entitled to | fees because the denial was |
| | | | full compensation, consequential | consistent with the policy terms and |
| | | | damages, attorney's fees, and | conducted in good faith under |
| | | | arbitration costs due to | Oregon law. |
| | | | NorthStar's bad faith and | |
| | | | unreasonable denial of the claim. | |
| 45 | Kentucky | Data Privacy | The brief addresses a dispute in | The brief addresses a dispute where |
| | | | which BlueHaven Financial | SecureNet IT Services defends |
| | | | Group alleges that SecureNet IT | against allegations of failing to |
| | | | Services breached a managed | uphold cybersecurity obligations, |
| | | | services agreement by failing to | arguing that BlueHaven Financial |
| | | | maintain adequate cybersecurity | Group's data breach resulted from |
| | | | protections and promptly respond | its own negligence, refusal to |
| | | | to a data breach, resulting in | implement recommended security |
| | | | significant financial losses, | measures, and employee errors, |
| | | | reputational harm, and regulatory | rather than any breach by |
| | | | scrutiny. | SecureNet. |
| | | | BlueHaven argues that SecureNet | SecureNet contends that it fulfilled |
| | | | materially breached its | its contractual obligations by |
| | | | contractual and professional | providing professional services and |
| | | | obligations by failing to | timely recommendations, and |
| | | | implement industry-standard | asserts that BlueHaven's claims for |
| | | | security measures and respond | damages and reimbursement lack |
| | | | promptly to a data breach, | merit because the breach resulted |
| | | | thereby causing foreseeable | from BlueHaven's own negligence |
| | | | damages, for which BlueHaven | and failure to implement critical |
| | | | seeks compensation, | security measures. |
| | | | reimbursement, and attorney's | |
| | | | fees. | |
| 49 | Colorado | Mining | The brief concerns a mining | The brief addresses a mining rights |
| | | rights and | rights and royalty dispute in | dispute where RedRock Resources |
| | | royalty | which Northern Ridge Mining, | Ltd. defends its actions to restrict |
| | | disputes | LLC alleges that RedRock | Northern Ridge Mining, LLC's |
| | | | Resources Ltd. materially | access to a Colorado property and |
| | | | breached their agreement by | withhold royalty payments, |
| | | | imposing unauthorized access | asserting these measures were |
| | | | restrictions and refusing royalty | necessary due to Northern Ridge's |
| | | | payments, resulting in financial | violations of environmental and |
| | | | losses and operational | safety regulations under their |
| | | | disruptions. | agreement. |
| | | | Northern Ridge argues that | RedRock argues that its access |
| | | | RedRock violated the agreement | restrictions and suspension of |
| | | | by obstructing access and | royalty payments were justified by |
| | | | rejecting royalty payments | Northern Ridge's breaches of |
| | | | without legal basis, entitling | environmental and safety |
| | | | Northern Ridge to compensation | obligations, which exposed |
| | | | for unpaid royalties, damages for | RedRock to significant legal risks, |
| | | | lost revenue, and recovery of | and asserts that Northern Ridge's |
| | | | attorney's fees due to RedRock's | claims for unpaid royalties, |
| | | | breach and bad faith conduct. | damages, and attorney's fees lack |
| | | | | merit as the losses stem from |
| | | | | Northern Ridge's own non- |
| | | | | compliance. |
| 80 | New York | Profit | The brief concerns a profit- | The brief addresses a profit-sharing |
| | | Sharing | sharing dispute in which Beacon | dispute in which Sterling |
| | | | Partners LLC alleges that Sterling | Collective, Inc. argues that Beacon |
| | | | Collective, Inc. breached their | Partners LLC failed to meet |
| | | | partnership agreement by | performance metrics under their |
| | | | withholding $250,000 in profit | partnership agreement, justifying |
| | | | shares, despite Beacon's full | Sterling's withholding of profit |
| | | | performance of its contractual | shares and rejection of Beacon's |
| | | | obligations. | claims for damages. |
| | | | Beacon contends that Sterling | Sterling contends that its |
| | | | breached the partnership | withholding of profit shares was |
| | | | agreement by failing to pay the | consistent with the partnership |
| | | | agreed profit shares without any | agreement, as Beacon's |
| | | | valid evidence of deficient | contributions were minimal and did |
| | | | performance, entitling Beacon to | not meet the agreed-upon |
| | | | the withheld $250,000, interest, | performance standards, making |
| | | | and reimbursement of attorney's | Beacon's claims for profit shares, |
| | | | fees and arbitration costs under | interest, and attorney's fees |
| | | | the agreement. | unjustified. |
| 99 | Georgia | Health | The brief addresses a dispute in | The brief concerns a dispute in |
| | | Insurance | which Genetix Solutions, LLC | which BioMosaic Innovations, Inc. |
| | | Denial | accuses BioMosaic Innovations, | denies allegations of intellectual |
| | | | Inc. of breaching a confidentiality | property infringement and breach of |
| | | | and licensing agreement by | contract brought by Genetix |
| | | | infringing on Genetix's | Solutions, LLC, asserting that its |
| | | | intellectual property, disclosing | developments were independently |
| | | | proprietary technology to a third | derived and that its actions |
| | | | party, and improperly | complied with the terms of their |
| | | | sublicensing it, causing financial | confidentiality and licensing |
| | | | and reputational harm. | agreement. |
| | | | Genetix asserts that BioMosaic | BioMosaic argues that it did not |
| | | | materially breached their | infringe Genetix's intellectual |
| | | | agreement by unauthorized use, | property or violate the agreement, |
| | | | disclosure, and sublicensing of | as its advancements were based on |
| | | | Genetix's proprietary technology, | independent methodologies, the |
| | | | entitling Genetix to damages, | alleged breaches are |
| | | | injunctive relief to prevent further | unsubstantiated, and any ambiguity |
| | | | misuse, and reimbursement for | in the agreement justifies dismissing |
| | | | legal and arbitration costs. | Genetix's claims and awarding |
| | | | | BioMosaic reimbursement of |
| | | | | arbitration costs and legal fees. |

In various embodiments, results generated by the disclosed systems, methods, and computer-readable media may be compiled and reported in a structured data file, including, for example, a comma-separated value file. In some embodiments, relevant descriptive statistics associated with the generated results may be compiled and represented in Table 2. In various embodiments, rates of hallucination, completeness, and groundedness may be reported on a per-topic basis in Table 3. In some embodiments, outcomes associated with selected scenarios may be reported in Table 4.

In one example evaluation reflected by the reported results, the disclosed system may perform such that generated outputs do not hallucinate, answer the issues in controversy, and, with limited exceptions, ground those answers in relevant case law. In various embodiments, the evaluation represented in Table 3 may identify narrow exceptions in which groundedness is reduced relative to other outputs. In this manner, the reported results may indicate that the disclosed system is capable of producing responsive rulings that resolve disputed issues while maintaining citation-based legal support in most evaluated scenarios.

In various embodiments, the reported results may also be categorized according to prevailing-party outcomes in order to identify outcome tendencies across different classes of disputes. In one example dataset, the system may generally rule in favor of the respondent. In some embodiments, such an outcome distribution may indicate structural bias. In other embodiments, the distribution may instead reflect characteristics of the underlying disputes, including that disputes favoring respondents may be more qualitatively rooted in law, whereas many claimant arguments may invoke equitable claims. In various embodiments, this distinction may be particularly pronounced in insurance-related matters, and such topic-specific results may be reflected in the per-topic reporting of Table 3.

In various embodiments, the reported results may also show topic-specific tendencies in the opposite direction. For example, in some datasets, corporate cases may disproportionately favor the claimant, and such scenario-level or category-level outcomes may be reflected in Table 4. Because evaluation may be conducted using a limited sample size, broader conclusions may be generalized with caution. Even so, in some embodiments, the results represented in Tables 2-4 may indicate that the disclosed system operates at a level superior to benchmarked legal products with respect to one or more of hallucination, completeness, groundedness, or overall performance.

TABLE 2
Descriptive Statistics

| | Cases | | |
|---|---|---|---|
| Topic | Claimant Wins | Respondent Wins | Aggregate |
| Contract | 22 | 40 | 62 |
| Insurance | 2 | 10 | 12 |
| Intellectual Property | 4 | 7 | 11 |
| Employment | 2 | 3 | 5 |
| Real Estate | 0 | 3 | 3 |
| Corporate | 4 | 1 | 5 |
| Other | 0 | 2 | 2 |
| Total | 34 | 66 | 100 |

TABLE 3
Graded Results¹

| | Cases | | |
|---|---|---|---|
| Topic | Hallucination | Correctness | Groundedness |
| Contract | 0 | 0 | 2 |
| Insurance | 0 | 0 | 0 |
| Intellectual Property | 0 | 0 | 0 |
| Employment | 0 | 0 | 0 |
| Real Estate | 0 | 0 | 0 |
| Corporate | 0 | 0 | 0 |
| Other | 0 | 0 | 0 |
| Total | 0 | 0 | 2 |

¹We reported the frequency of the issue. Thus, a ‘0’ reports no presence of the given metric. A 0 for hallucination means there were 0 hallucinations; a 0 for correctness, means that each brief had the issues in controversy answered; and a 0 for groundedness means that each brief had the relevant law applied.

TABLE 4
Selected Scenarios Results

| | Prevailing | |
|---|---|---|
| Case ID | Party | Selected Excerpt of Ruling |
| 4 | Respondent | This case presents a classic dispute over the interpretation of an executive employment |
| | | contract and the circumstances surrounding termination. The claimant, Victoria Green, |
| | | argues that Summit Dynamics breached her employment contract by failing to provide |
| | | severance and equity compensation after her termination, which she contends was without |
| | | cause. In contrast, the respondent, Summit Dynamics, asserts that Green was terminated for |
| | | cause due to gross mismanagement and breaches of fiduciary duty, which exempted them |
| | | from paying severance and equity compensation. After considering the arguments, I rule in |
| | | favor of Summit Dynamics, as the evidence presented supports their claim of termination for |
| | | cause based on documented performance failures and breaches of fiduciary duty. |
| | | . . . |
| | | The legal issue at hand is whether Summit Dynamics Corporation's termination of Victoria |
| | | Green was for cause, thereby exempting them from their contractual obligations to provide |
| | | severance and equity compensation. |
| | | Rule: Under Illinois law, an employer may terminate an employee for cause if the employee |
| | | engages in gross misconduct or breaches fiduciary duties as defined in their employment |
| | | contract. In the case of Martin v. Federal Life Insurance Co., 518 N.E.2d 306 (III. App. Ct. |
| | | 1987), the court addressed the enforceability of employment contracts and the conditions |
| | | under which an employer may terminate an employee without fulfilling severance |
| | | obligations. The court found that an employer's failure to adhere to contractual obligations |
| | | could be justified if the employee's actions constituted a breach of the contract or |
| | | misconduct. |
| | | In Martin, the plaintiff alleged wrongful termination based on an oral agreement for |
| | | permanent employment. The court examined whether the employer's actions were justified |
| | | under the terms of the contract and the applicable law. The court ultimately ruled that the |
| | | employer's claims of misconduct were sufficient to uphold the termination, thereby allowing |
| | | the employer to avoid severance payments. |
| | | Application: In the present case, Victoria Green's termination was based on allegations of |
| | | gross mismanagement and breaches of fiduciary duty. Summit Dynamics claims that Green's |
| | | approval of a $500,000 advertising campaign that violated contractual agreements with a |
| | | major client, her exceeding the department's budget by 25% without authorization, and the |
| | | creation of a toxic work environment justify her termination for cause. These allegations |
| | | parallel the misconduct discussed in Martin, where the court upheld the employer's right to |
| | | terminate based on the employee's actions that violated company policies and standards. |
| | | Factually, both cases involve an employee whose actions led to significant negative |
| | | consequences for the employer. In Martin, the employee's alleged misconduct was sufficient |
| | | to justify termination without severance. Similarly, Green's actions, as claimed by Summit |
| | | Dynamics, resulted in financial losses and reputational harm to the company, which could be |
| | | interpreted as gross misconduct under the terms of her employment contract. |
| | | Moreover, the employment contract in Green's case explicitly states that severance and |
| | | equity provisions apply only in the event of termination without cause. Since Summit |
| | | Dynamics asserts that Green's termination was for cause, they argue that they are not |
| | | obligated to fulfill these provisions. This aligns with the ruling in Martin, where the court |
| | | found that the employer was justified in terminating the employee based on documented |
| | | misconduct, thus negating any claims for severance. |
| | | Conclusion: Based on the legal precedent established in Martin v. Federal Life Insurance |
| | | Co., Summit Dynamics Corporation's termination of Victoria Green appears to be justified |
| | | under the terms of her employment contract and Illinois law. The allegations of gross |
| | | mismanagement and breaches of fiduciary duty provide a sufficient basis for the termination |
| | | to be classified as for cause, thereby exempting Summit from their contractual obligations to |
| | | provide severance and equity compensation. As such, the ruling should favor Summit |
| | | Dynamics in this arbitration. |
| 17 | Claimant | In this construction payment dispute, the stakes are high as both parties assert their rights |
| | | under the contract. Crescent Bay Builders, LLC claims entitlement to $180,000 for |
| | | completed work and approved change orders, arguing that they fulfilled all contractual |
| | | obligations and that Riverfront's claims of budget overruns and subcontractor issues are |
| | | unfounded. Conversely, Riverfront Commercial Development Group contends that Crescent |
| | | Bay delivered substandard work and missed deadlines, justifying their withholding of |
| | | payments and asserting that Crescent Bay's claims for additional compensation are |
| | | unsupported by the contract. After considering the arguments, I rule in favor of Crescent |
| | | Bay Builders, LLC, as they have demonstrated compliance with the contract and provided |
| | | sufficient documentation to support their claims for payment. |
| | | . . . |
| | | Legal Analysis |
| | | The legal issue at hand is whether Crescent Bay Builders, LLC is entitled to recover the |
| | | $180,000 in unpaid amounts for completed work and approved change orders under the |
| | | terms of the construction contract with Riverfront Commercial Development Group. |
| | | Rule: A contractor may withhold payment for work that does not meet contractual standards |
| | | or for which there is a legitimate dispute regarding the quality of the work performed. This |
| | | principle is illustrated in the case of Hester v. Burns Builders, 92 So. 3d 641 (La. Ct. App. |
| | | 2012). In Hester, the plaintiff refused to issue a scheduled progress payment due to alleged |
| | | defects in the construction work performed by the defendant. The court emphasized that |
| | | genuine issues of material fact regarding the alleged defects could justify withholding |
| | | payment. |
| | | In Hester, the factual context involved a contract for the construction of a new home, where |
| | | the plaintiff contended that the quality of the defendant's work was sub-par. The plaintiff |
| | | hired an expert to inspect the work, which led to the refusal to authorize further payments. |
| | | The trial court initially granted summary judgment in favor of the defendant, but the |
| | | appellate court reversed this decision, highlighting that the existence of genuine issues of |
| | | material fact regarding the quality of work warranted further proceedings. |
| | | Application: In the current dispute between Crescent Bay and Riverfront, similar issues arise |
| | | regarding the quality of work and the entitlement to payment. Crescent Bay claims that it |
| | | completed all work in compliance with the contract, including several change orders that |
| | | were requested and approved by Riverfront. The project passed inspection and was delivered |
| | | on schedule, which aligns with the plaintiff's position in Hester, where the work was also |
| | | completed and inspected. |
| | | Conversely, Riverfront contends that Crescent Bay delivered substandard work and missed |
| | | deadlines, justifying their withholding of payments. This assertion mirrors the defendant's |
| | | position in Hester, where the defendant claimed that the plaintiff's refusal to pay was |
| | | unfounded. However, just as in Hester, the key factor is whether there are genuine issues of |
| | | material fact regarding the quality of the work performed by Crescent Bay. |
| | | Crescent Bay has provided detailed invoices and documentation of the completed work, |
| | | similar to the expert report presented by the plaintiff in Hester. Riverfront's claims of budget |
| | | overruns and subcontractor performance issues are vague and unsupported, akin to the |
| | | defendant's arguments in Hester that did not sufficiently counter the plaintiff's evidence. The |
| | | court in Hester ruled that the existence of such disputes warranted further examination, |
| | | which is applicable here as well. |
| | | Based on the legal principles established in Hester v. Burns Builders, Crescent Bay Builders, |
| | | LLC has demonstrated compliance with the contract and provided sufficient documentation |
| | | to support its claims for payment. The genuine issues of material fact regarding the quality |
| | | of work and the legitimacy of Riverfront's claims necessitate a ruling in favor of Crescent |
| | | Bay. Therefore, Crescent Bay is entitled to recover the $180,000 in unpaid amounts for |
| | | completed work and approved change orders. |
| 24 | Respondent | This case revolves around Harper Industries' claim against NorthStar Insurance Company |
| | | for coverage of losses resulting from a fire at its manufacturing facility. The claimant, |
| | | Harper, argues that the fire was a covered peril under the policy and that NorthStar |
| | | wrongfully denied coverage despite Harper's compliance with all policy terms. Harper |
| | | contends that the exclusions cited by NorthStar, namely “negligence in maintenance” and |
| | | “wear and tear,” are inapplicable to the circumstances of the loss, as the fire was caused by |
| | | an unexpected electrical fault. |
| | | In contrast, the respondent, NorthStar, asserts that the denial was justified based on the |
| | | policy exclusions for inadequate maintenance and wear and tear, claiming that Harper's |
| | | failure to maintain its equipment directly contributed to the fire. NorthStar argues that the |
| | | fire was not an independent event but rather a result of foreseeable equipment failure due to |
| | | neglect. |
| | | After considering the arguments presented, I rule in favor of NorthStar Insurance Company, |
| | | as the evidence supports that Harper's lack of maintenance contributed to the incident, |
| | | falling within the policy exclusions. |
| | | . . . |
| | | Legal Analysis |
| | | Issue: The legal issue at hand is whether NorthStar Insurance Company properly denied |
| | | coverage for Harper Industries' claim based on the exclusions for “negligence in |
| | | maintenance” and “wear and tear” in the insurance policy. |
| | | Rule: Under Oregon law, an insurer may deny coverage based on specific exclusions |
| | | outlined in the policy if the circumstances of the claim fall within those exclusions. In the |
| | | case of Palmrose v. Oregon Insurance Guaranty Association, 205 Or. App. 613 (Or. Ct. App. |
| | | 2006), the court held that a claim was not covered because the insurer was not a member of |
| | | the Oregon Insurance Guaranty Association at the time of the incident, and the policy did |
| | | not meet the statutory requirements for coverage. The court emphasized that the definitions |
| | | of “covered claim” and “insolvent insurer” are critical in determining coverage eligibility. |
| | | In Palmrose, the facts involved a personal injury and wrongful death claim against an |
| | | assisted living center, where the insurance policy was issued by a surplus lines insurer that |
| | | later became insolvent. The court ruled that the claim was not covered because the policy |
| | | did not apply under the relevant statutes, highlighting the importance of the insurer's status |
| | | and the nature of the policy in determining coverage. |
| | | Application: In the current case, Harper Industries submitted a claim for $1.2 million in |
| | | damages resulting from a fire at its manufacturing facility. NorthStar Insurance Company |
| | | denied the claim, citing exclusions for “negligence in maintenance” and “wear and tear.” The |
| | | facts indicate that the fire was caused by an electrical fault, which NorthStar argues was |
| | | exacerbated by Harper's failure to maintain its equipment properly. |
| | | Comparing the facts of Palmrose to the current case, both involve claims where the insurer |
| | | seeks to deny coverage based on specific policy exclusions. In Palmrose, the insurer's status |
| | | and the nature of the policy were critical in determining coverage eligibility. Similarly, in |
| | | this case, NorthStar's reliance on the maintenance exclusions is central to its denial of |
| | | Harper's claim. The rule established in Palmrose suggests that if the circumstances of the |
| | | claim align with the exclusions outlined in the policy, the insurer may rightfully deny |
| | | coverage. |
| | | In applying the rule to the facts, it is evident that Harper's alleged lack of maintenance |
| | | directly contributed to the incident leading to the claim. NorthStar's argument that the fire |
| | | was a result of inadequate maintenance aligns with the exclusions stated in the policy. Just |
| | | as the court in Palmrose ruled that the claim was not covered due to the insurer's status and |
| | | the policy's limitations, NorthStar's denial of coverage is justified based on the exclusions |
| | | for negligence and wear and tear. |
| | | Conclusion: Based on the analysis of the issue, rule, and application of the relevant case law, |
| | | it is concluded that NorthStar Insurance Company properly denied coverage for Harper |
| | | Industries' claim. The evidence supports that Harper's lack of maintenance contributed to the |
| | | incident, falling within the policy exclusions. Therefore, the ruling should favor NorthStar |
| | | Insurance Company, affirming its denial of the claim based on the applicable exclusions in |
| | | the insurance policy. |
| 45 | Claimant | This arbitration case highlights the critical importance of cybersecurity in the modern |
| | | business landscape. The claimant, BlueHaven Financial Group, LLC, argues that SecureNet |
| | | IT Services, Inc. breached their managed services agreement by failing to provide adequate |
| | | security measures, resulting in a data breach that exposed sensitive client information and |
| | | caused significant financial losses. BlueHaven claims damages of $350,000 for financial |
| | | losses, $75,000 for reimbursement of fees paid, and attorney's fees. In contrast, the |
| | | respondent, SecureNet, contends that it fulfilled its contractual obligations and that the |
| | | breach was primarily due to BlueHaven's internal failures, including its refusal to implement |
| | | recommended security measures and inadequate employee training. After considering the |
| | | arguments, I rule in favor of BlueHaven Financial Group, LLC, as SecureNet's failure to |
| | | implement basic cybersecurity protocols directly contributed to the breach and the resulting |
| | | damages. |
| | | . . . |
| | | Legal Analysis |
| | | Issue: The legal issue at hand is whether SecureNet IT Services, Inc. breached its contractual |
| | | obligations to BlueHaven Financial Group, LLC by failing to implement adequate |
| | | cybersecurity measures, resulting in a data breach that exposed sensitive client information. |
| | | Rule: Under Kentucky law, service providers have a duty to exercise reasonable care in |
| | | protecting their clients' sensitive information. This duty includes implementing industry - |
| | | standard security measures to prevent data breaches. The Kentucky Personal Information |
| | | Security Breach Notification Requirements outline the obligations of agencies regarding |
| | | data security and breach notifications, emphasizing the importance of timely and effective |
| | | responses to security incidents (KRS 61.931 to 61.934). |
| | | Application: In the case of BlueHaven Financial Group, LLC v. SecureNet IT Services, Inc., |
| | | the facts reveal that BlueHaven entered into a managed services agreement with SecureNet, |
| | | which included responsibilities for monitoring IT systems, implementing encryption, |
| | | conducting vulnerability assessments, and responding to incidents within two hours. |
| | | However, SecureNet failed to implement multi-factor authentication (MFA) and did not |
| | | adequately update its email gateway, which left BlueHaven's systems vulnerable to a |
| | | phishing attack. This breach exposed the personal financial information of approximately |
| | | 2,000 clients and resulted in significant financial losses and reputational harm for |
| | | BlueHaven. |
| | | Comparatively, the Kentucky Personal Information Security Breach Notification |
| | | Requirements establish that organizations must notify affected individuals and relevant |
| | | authorities of a breach within a specified timeframe. In this case, SecureNet's failure to |
| | | detect the breach until 72 hours after it began directly contravenes the expectations set forth |
| | | in the law. The lack of timely response and inadequate security measures demonstrate a |
| | | breach of the duty of care owed to BlueHaven. |
| | | Furthermore, the rule applies to the facts of this case as SecureNet's actions (or lack thereof) |
| | | directly led to the breach. The failure to implement basic cybersecurity protocols, such as |
| | | MFA, constitutes a clear violation of the contractual obligations outlined in the managed |
| | | services agreement. The breach not only resulted in financial losses for BlueHaven but also |
| | | triggered regulatory investigations and client complaints, further exacerbating the harm |
| | | caused. |
| | | Conclusion: Based on the analysis of the legal issue, the applicable rule, and the application |
| | | of the facts to the rule, it is evident that SecureNet IT Services, Inc. breached its contractual |
| | | obligations to BlueHaven Financial Group, LLC. The failure to implement adequate |
| | | cybersecurity measures and respond promptly to the breach directly contributed to the |
| | | significant financial and reputational harm suffered by BlueHaven. Therefore, BlueHaven is |
| | | entitled to the relief sought in this arbitration, including damages for financial losses, |
| | | reimbursement of fees, and attorney's fees. |
| | | Conclusion |
| | | After considering the arguments, I rule in favor of BlueHaven Financial Group, LLC, as |
| | | SecureNet's failure to implement basic cybersecurity protocols directly contributed to the |
| | | breach and the resulting damages. |
| 49 | Respondent | In this arbitration dispute, the tension between mining rights and contractual obligations |
| | | takes center stage. The claimant, Northern Ridge Mining, LLC, argues that RedRock |
| | | Resources Ltd. breached their mining rights and royalty agreement by restricting access and |
| | | refusing to accept royalty payments, resulting in $300,000 in unpaid royalties and $150,000 |
| | | in damages. Conversely, the respondent, RedRock, contends that Northern Ridge violated |
| | | environmental and safety regulations, justifying their actions to restrict access and suspend |
| | | royalty payments. After considering the arguments, I rule in favor of RedRock Resources |
| | | Ltd. because Northern Ridge's non-compliance with the agreement's terms undermines its |
| | | claims for unpaid royalties and damages. |
| | | . . . |
| | | Legal Analysis |
| | | The primary legal issue is whether RedRock Resources Ltd. breached the mining rights and |
| | | royalty agreement with Northern Ridge Mining, LLC by restricting access and refusing to |
| | | accept royalty payments, or whether Northern Ridge's alleged violations of environmental |
| | | and safety regulations justified RedRock's actions. |
| | | Rule: The rule governing this dispute is that parties to a contract must adhere to the specific |
| | | terms of the agreement, and any unilateral changes or breaches can lead to liability. In the |
| | | case of Gypsum Aggregates Corp. v. Lionelle, 170 Colo. 282 (Colo. 1969), the court |
| | | emphasized the importance of the parties' adherence to the terms of their agreement |
| | | regarding mining claims. The court found that the determination of the nature of mineral |
| | | deposits was a factual issue that needed to be resolved based on the evidence presented, and |
| | | the trial court's findings were upheld due to the presence of competent evidence supporting |
| | | its conclusions. |
| | | In Gypsum Aggregates Corp. v. Lionelle, the plaintiff sought a declaration regarding the |
| | | nature of a mineral deposit and whether it was subject to location as a placer or lode mining |
| | | claim. The trial court found that the deposit was placer in nature, and the plaintiff's request |
| | | for a new trial based on insufficient evidence was denied. The court ruled that the trial |
| | | court's findings were supported by competent evidence, reinforcing the principle that |
| | | contractual obligations must be honored unless a valid reason for non-compliance is |
| | | established. |
| | | Application: In the current dispute, Northern Ridge Mining, LLC claims that RedRock |
| | | Resources Ltd. breached their agreement by imposing access restrictions and refusing to |
| | | accept royalty payments. Northern Ridge argues that it complied with the terms of the |
| | | agreement, including timely royalty payments and adherence to operational guidelines. |
| | | However, RedRock contends that Northern Ridge violated environmental and safety |
| | | regulations, which justified their actions to restrict access and suspend royalty payments. |
| | | Factually, both cases involve disputes over compliance with contractual obligations. In |
| | | Gypsum Aggregates Corp. v. Lionelle, the court upheld the trial court's findings based on |
| | | the evidence presented regarding the nature of the mineral deposit. Similarly, in the current |
| | | case, the determination of whether Northern Ridge complied with environmental regulations |
| | | is crucial. If Northern Ridge did indeed violate these regulations, as RedRock claims, then |
| | | RedRock's actions to restrict access may be justified under the terms of the agreement. |
| | | Furthermore, the Gypsum case illustrates that the burden of proof lies with the party |
| | | claiming a breach. In this instance, Northern Ridge must demonstrate that RedRock's actions |
| | | were unjustified and constituted a breach of the agreement. Conversely, RedRock must |
| | | provide evidence of Northern Ridge's non-compliance with environmental regulations to |
| | | support its defense. |
| | | Conclusion: Based on the analysis of the legal issue, the applicable rule, and the factual |
| | | context of both cases, it can be concluded that RedRock Resources Ltd.'s actions may be |
| | | justified if Northern Ridge Mining, LLC is found to have violated the terms of the |
| | | agreement regarding environmental and safety regulations. The precedent set in Gypsum |
| | | Aggregates Corp. v. Lionelle reinforces the importance of adhering to contractual |
| | | obligations and the necessity of providing competent evidence to support claims of breach. |
| | | Therefore, if Northern Ridge cannot sufficiently demonstrate compliance with the |
| | | agreement, the ruling should favor RedRock. |
| 80 | Claimant | In a classic case of contractual disagreement, Beacon Partners LLC claims that Sterling |
| | | Collective, Inc. has unjustly withheld profit shares despite fulfilling its obligations. The |
| | | claimant, Beacon, argues that it successfully contributed to securing contracts that generated |
| | | significant profits and that Sterling's claims of deficient performance are vague and |
| | | unsupported. Conversely, the respondent, Sterling, contends that Beacon failed to meet the |
| | | necessary performance metrics outlined in their partnership agreement, justifying their |
| | | decision to withhold payments. After considering the arguments, I rule in favor of Beacon |
| | | Partners LLC, as Sterling's lack of specific evidence to support its claims of deficient |
| | | performance constitutes a breach of the partnership agreement. |
| | | . . . |
| | | Legal Analysis |
| | | Issue: The legal issue at hand is whether Sterling Collective, Inc.'s withholding of profit |
| | | shares from Beacon Partners LLC constitutes a breach of the partnership agreement. |
| | | Rule: The rule governing this issue is that a party may not withhold payments under a |
| | | contract without specific evidence justifying such action. In the case of Greenberg v. |
| | | Ladicorbic, 200 A.D.2d 465 (N.Y. App. Div. 1994), the court held that claims premised on |
| | | the existence of a partnership must fail in the absence of evidence showing that the claimant |
| | | contributed to the capital of the alleged partnership or was to share in its losses. The court |
| | | emphasized that without evidence supporting the claims, the party withholding payment |
| | | could not justify its actions. |
| | | In Greenberg, the plaintiff sought relief based on the assertion of a partnership, but the court |
| | | found that there was no evidence of capital contribution or shared losses, leading to the |
| | | dismissal of the claims. The factual context involved a dispute over the existence of a |
| | | partnership and the obligations arising from it, where the court required concrete evidence to |
| | | support the claims made by the plaintiff. |
| | | Application: In the present case, Beacon Partners LLC claims that Sterling Collective, Inc. |
| | | has unjustly withheld profit shares amounting to $250,000, despite Beacon fulfilling its |
| | | obligations under the partnership agreement. Similar to the Greenberg case, where the court |
| | | required evidence of partnership contributions, Beacon must demonstrate that it met the |
| | | performance metrics outlined in the agreement to justify its entitlement to the profit shares. |
| | | Factually, Beacon asserts that it contributed to securing contracts that generated $1.67 |
| | | million in profits for Sterling, which aligns with the requirement of demonstrating value- |
| | | added contributions. In contrast, Sterling claims that Beacon's performance was deficient |
| | | and that it failed to meet the necessary metrics. However, Sterling's assertions lack specific |
| | | evidence, as they have not provided documentation to substantiate their claims of Beacon's |
| | | underperformance. This parallels the Greenberg case, where the absence of evidence led to |
| | | the dismissal of claims. |
| | | Furthermore, in Greenberg, the court highlighted that the existence of a partnership must be |
| | | supported by evidence of capital contribution or shared losses. In this arbitration, Beacon's |
| | | entitlement to profit shares is based on the partnership agreement, which explicitly states |
| | | that Beacon is entitled to 15% of Sterling's profits. The lack of evidence from Sterling to |
| | | support its claims of deficient performance undermines its position, just as the absence of |
| | | evidence in Greenberg led to the dismissal of the plaintiff's claims. |
| | | Conclusion: Based on the analysis of the legal rule established in Greenberg v. Ladicorbic |
| | | and its application to the present case, it is clear that Sterling Collective, Inc.'s withholding |
| | | of profit shares from Beacon Partners LLC constitutes a breach of the partnership |
| | | agreement. The absence of specific evidence to support Sterling's claims of deficient |
| | | performance, coupled with Beacon's fulfillment of its obligations, supports a ruling in favor |
| | | of Beacon. Therefore, Beacon is entitled to the relief sought, including the immediate |
| | | payment of $250,000 in profit shares, interest, and reimbursement for legal fees and |
| | | arbitration costs. |
| 99 | Respondent | In a case that highlights the complexities of insurance enrollment, Emily Carter contends |
| | | that Atlantic Health Assurance unjustly denied her health insurance claim. The claimant |
| | | argues that she acted in good faith, promptly submitting the required documentation and |
| | | reasonably believing her application was approved based on Atlantic's communication. |
| | | Conversely, Atlantic maintains that Carter's application was incomplete due to insufficient |
| | | proof of income, which she failed to rectify despite multiple requests for additional |
| | | documentation. After considering the arguments, the ruling is in favor of Atlantic Health |
| | | Assurance, as the claimant did not fulfill the necessary requirements outlined in the |
| | | insurance policy to activate her coverage. |
| | | . . . |
| | | Legal Analysis |
| | | The legal issue at hand is whether Atlantic Health Assurance, Inc. was justified in denying |
| | | Emily Carter's health insurance claim based on her alleged failure to provide complete and |
| | | verifiable documentation during the application process. |
| | | Rule: An insurance company has a duty to communicate clearly and in good faith with |
| | | applicants regarding the status of their applications and any deficiencies that may exist. This |
| | | duty includes providing timely feedback and opportunities for applicants to rectify any |
| | | issues that could prevent the activation of their coverage. This principle is supported by the |
| | | ruling in Lucas v. State Farm Fire & Casualty Co., 864 F. Supp. 2d 1346 (M.D. Ga. 2012), |
| | | where the court found that the insured's failure to comply with policy conditions justified the |
| | | insurer's denial of coverage. |
| | | In Lucas, the plaintiff, R. Wesley Lucas, filed a claim for fire loss under his homeowner's |
| | | insurance policy with State Farm. The court found that Lucas breached the insurance |
| | | contract by failing to submit to a required examination under oath, which was a condition |
| | | precedent to bringing suit. The court emphasized that the insurer is entitled to require its |
| | | insured to abide by the policy terms, and failure to comply with such conditions precludes |
| | | recovery as a matter of law. |
| | | Application: In the case of Emily Carter, she submitted her application for health insurance |
| | | coverage to Atlantic Health Assurance, which required personal identification, proof of |
| | | income, and prior coverage documentation. On July 15, 2024, Atlantic informed Carter that |
| | | her proof of income was insufficient and requested an updated version. Carter promptly |
| | | provided the requested documentation on July 18, 2024. However, she received no further |
| | | communication from Atlantic regarding her application, leading her to reasonably believe |
| | | that her application was complete and approved. |
| | | Comparing this to the facts in Lucas, both cases involve an applicant who submitted |
| | | documentation to an insurance company and received communication regarding the status of |
| | | their application. In Lucas, the plaintiff's failure to comply with the requirement for an |
| | | examination under oath resulted in the denial of his claim. Similarly, in Carter's case, |
| | | Atlantic's communication regarding the insufficiency of her proof of income created an |
| | | obligation for her to rectify the issue. However, unlike Lucas, where the insured failed to |
| | | comply with a clear requirement, Carter believed she had fulfilled her obligations based on |
| | | the absence of further requests and the automated confirmation message from Atlantic. |
| | | The key distinction lies in the clarity of communication from the insurer. In Lucas, the court |
| | | found that the insured's non-compliance with the policy conditions justified the insurer's |
| | | denial of coverage. In Carter's situation, Atlantic's failure to provide timely feedback after |
| | | her second submission left her without the opportunity to address any deficiencies, which |
| | | contributed to her belief that her application was approved. This lack of communication may |
| | | indicate that Atlantic did not fully uphold its duty to inform Carter of the status of her |
| | | application. |
| | | Conclusion: Based on the principles established in Lucas v. State Farm Fire & Casualty Co., |
| | | Atlantic Health Assurance, Inc. may have acted within its rights to deny Emily Carter's |
| | | claim due to her failure to provide complete documentation. However, the insurer's lack of |
| | | clear communication regarding the status of her application and the insufficiency of her |
| | | proof of income raises questions about whether it fulfilled its duty to inform her adequately. |
| | | Given these circumstances, while Atlantic may have a valid basis for denying the claim, the |
| | | failure to communicate effectively could undermine its position, suggesting that the denial |
| | | may not be entirely justified. |

In some embodiments, the disclosed systems, methods, and computer-readable media may provide a more neutral and consistent adjudicative or recommendation-generating process by reducing dependence on the individual predispositions, external incentives, or personal conflicts that may affect human decision makers. In various embodiments, because the disclosed platform may operate according to defined computational workflows, model selections, input constraints, and evaluation routines, the resulting outputs may be generated in a manner that is more standardized and more readily reviewable than processes that depend primarily on human discretion.

In some embodiments, a further benefit of the disclosed platform may be that system behavior is traceable through stored prompts, configurations, source selections, intermediate outputs, model routing decisions, and other recorded processing data. As a result, where a particular output is challenged, audited, or reviewed, the underlying computational steps may be examined to determine how the output was produced. In various embodiments, this traceability may facilitate identification of attempted manipulation, configuration errors, biased source selection, or other distortions affecting the quality of the result.

In some embodiments, the disclosed platform may therefore improve transparency and accountability relative to processes in which the reasoning path of a human decision maker is not fully observable. Although no automated system is immune from misuse, poor configuration, or adversarial input, the disclosed embodiments may be structured such that the operative rules, filters, and data-processing steps are documented and capable of later inspection. In this manner, the disclosed embodiments may provide a more empirically auditable framework for generating neutral, consistent, and explainable outputs.

In various embodiments, the disclosed systems, methods, and computer-readable media may be configured to receive, store, organize, analyze, and weigh evidence submitted by one or more parties in connection with an automated arbitration, mediation, adjudication, or other dispute-resolution process. In some embodiments, the evidence may include any information that is relevant or material to a dispute, regardless of whether the evidence conforms to formal rules of evidence applicable in a judicial proceeding. For example, the system may receive pleadings, briefs, claims, answers, counterclaims, legal memoranda, contracts, invoices, purchase orders, correspondence, emails, text messages, chat logs, internal business records, accounting records, payment histories, shipping records, repair records, photographs, diagrams, spreadsheets, database extracts, medical records, insurance records, employment records, personnel files, policies, manuals, logs, reports, expert materials, demonstrative exhibits, and other documentary or electronically stored information. In some embodiments, the system may further receive affidavits, declarations, witness statements, deposition transcripts, hearing transcripts, prior testimony, arbitration transcripts, court filings, regulatory filings, and certified or uncertified copies of records obtained from third parties.

In various embodiments, the system may additionally receive multimedia evidence, including audio recordings, video recordings, surveillance footage, screen recordings, videoconference recordings, voicemail messages, and other media files. In some embodiments, audio or video evidence may be automatically processed to generate corresponding text, such as by speech-to-text transcription, speaker diarization, timestamp generation, segmentation by question and answer, identification of interruptions, and extraction of named entities or factual assertions. In some embodiments, optical character recognition may be applied to scanned exhibits, handwritten notes, photographed documents, whiteboard images, receipts, labels, or other image-based materials in order to convert such materials into machine-readable text. In this manner, the system may normalize evidence originating from different formats into a common representation suitable for indexing, searching, summarization, comparison, and adjudicative analysis.

In various embodiments, evidence submitted by the parties may be categorized according to one or more classification schemes. For example, the system may classify evidence by source, date, author, custodian, party, witness, issue, claim element, defense, jurisdiction, legal rule, factual topic, authenticity status, confidentiality level, and procedural stage. In some embodiments, the system may identify whether a submitted item is testimonial evidence, documentary evidence, demonstrative evidence, impeachment evidence, rebuttal evidence, expert evidence, real evidence, or metadata-derived evidence. In some embodiments, the system may further associate each evidence item with one or more disputed issues, such as liability, causation, damages, notice, breach, performance, waiver, mitigation, credibility, or interpretation of a contractual provision. The system may thereby organize the evidentiary record into issue-specific or party-specific groupings that may be used during an automated hearing and in subsequent opinion generation.

In various embodiments, the system may also generate and manage exhibits. For example, submitted files may be assigned exhibit identifiers, grouped into exhibit sets, linked to sponsoring witnesses, and associated with one or more statements of relevance supplied by a party or generated by the system. In some embodiments, the system may detect duplicates, substantially similar documents, conflicting versions of the same document, missing pages, altered files, inconsistent timestamps, or discrepancies between an original file and a later-submitted copy. In some embodiments, chain-of-custody information, file metadata, edit histories, transmission records, signature data, and access logs may also be treated as evidence or as evidence-bearing attributes relevant to authenticity, weight, and reliability.

In various embodiments, the system may receive witness or deponent evidence in text, audio, video, or multimodal form. For example, a witness may submit a written declaration, answer interrogatory-style questions through a text interface, participate in a live or asynchronous recorded interview, provide deposition testimony by video conference, or respond to prompts generated during an automated hearing. In some embodiments, the system may convert live testimony into time-aligned text and may segment the testimony into assertions, concessions, denials, explanations, and responses to specific questions. In various embodiments, the system may compare testimony from one witness against testimony from another witness, against documentary exhibits, against prior statements by the same witness, or against objective evidence in the record in order to identify consistency, inconsistency, omission, contradiction, or corroboration.

In various embodiments, the system may evaluate credibility of a witness, deponent, party representative, expert, or other source of evidence. In some embodiments, credibility may be assessed by determining whether a statement is corroborated by independent evidence, contradicted by contemporaneous records, inconsistent with earlier testimony, internally inconsistent, implausible in light of known facts, incomplete in response to a direct question, or materially altered over time. In some embodiments, the system may generate a credibility score, confidence score, reliability score, inconsistency score, corroboration score, or other evaluative metric for a particular statement, witness, exhibit, or evidentiary cluster. Such a score may be generated by one or more machine learning models, deep learning models, rules-based engines, statistical models, transformer models, graph-based models, ensemble models, or combinations thereof. In some embodiments, the score may be calculated from features including semantic consistency, factual overlap with other evidence, deviation from prior testimony, response latency, linguistic hedging, level of detail, specificity, contradiction frequency, citation support, source provenance, and document authenticity indicators.

In some embodiments, where video or audio evidence is available, the system may analyze additional signals that may be used as inputs to a credibility assessment model. For example, the system may analyze speaker identity, turn-taking behavior, interruptions, hesitations, pauses, changes in tone, speaking rate, word repetition, evasive phrasing, and other paralinguistic or discourse-level features. In some embodiments, video analysis may further include evaluation of facial movement, gaze direction, posture changes, gesture patterns, or other observable behavioral features. In various embodiments, such signals need not be dispositive and may instead be used as one set of features among a larger body of corroborating or contradicting evidence. In some embodiments, the system may assign greater weight to objective consistency with the evidentiary record than to any single behavioral indicator.

In various embodiments, the disclosed system may conduct an automated hearing process in which the system generates one or more questions for a party, witness, deponent, custodian, or expert. In some embodiments, the questions may be generated based on identified gaps in the record, unresolved factual disputes, contradictory testimony, ambiguous contractual language, missing foundation for an exhibit, missing authentication information, or legal issues requiring clarification. In some embodiments, the system may generate follow-up questions dynamically in response to an answer received during the automated hearing. The responses to such system-generated questions may themselves be stored as evidence and may be categorized, scored, and weighed together with other materials in the record. In various embodiments, the system may determine whether a response is responsive, evasive, incomplete, contradictory, unsupported, or corroborated, and may use that determination in evaluating the merits of the dispute.

In some embodiments, the system may also consider other forms of evidence, including machine-generated logs, sensor outputs, geolocation data, transaction records, software usage logs, communication metadata, browser activity records, blockchain records, access-control logs, version histories, and audit trails. In some embodiments, the system may receive expert-generated analyses, damages calculations, industry standards, regulatory guidance, or external reference materials and may distinguish between adjudicative facts, background information, and legal authority. In various embodiments, each item of evidence may be assigned a relevance value, authenticity value, materiality value, credibility value, and issue linkage so that the system may determine how strongly the evidence bears on a particular claim, defense, or requested remedy.

In various embodiments, the system may use the categorized evidence and any associated credibility or reliability scores during one or more downstream operations, including summarization, issue framing, legal analysis, generation of tentative findings, generation of proposed awards, and generation of a final opinion. In some embodiments, the system may expressly identify which evidence supports or undermines a particular factual finding and may discount evidence that is uncorroborated, inconsistent, or assigned a low reliability score. In this manner, the disclosed systems, methods, and computer-readable media may permit an automated arbitrator to consider a broad range of evidentiary inputs, including party-submitted materials and responses to system-generated questions, while organizing and evaluating such evidence in a structured and reproducible manner.

In various embodiments, the disclosed systems, methods, and computer-readable media may be configured not only to determine which party prevails on one or more legal or factual issues, but also to determine an amount of monetary relief associated with those issue-by-issue determinations. In some embodiments, the system may resolve a dispute as a sequence of sub-issues, including, for example, contract formation, breach, causation, notice, excuse, waiver, performance, damages entitlement, mitigation, setoff, and affirmative defenses. Based on the resolution of those sub-issues, the system may determine whether a claimant, respondent, counterclaimant, or counter-respondent is entitled to monetary damages, and may further calculate an amount of such damages according to one or more applicable rules, contractual provisions, evidentiary inputs, or remedial frameworks.

In some embodiments, the system may associate particular categories of damages with particular issue findings. For example, if the system determines that a contract existed and was breached, the system may evaluate expectancy damages, reliance damages, restitution, liquidated damages, cover damages, repair costs, replacement costs, refund amounts, or other contract-based remedies. If the system determines that a defense applies, the system may reduce or eliminate recovery. If the system determines that only a subset of alleged breaches is proven, the system may award damages only for that subset. In this manner, the system may map liability findings to corresponding remedial consequences, such that monetary relief is tied to the specific issues on which a party prevails.

In various embodiments, the system may calculate damages using evidence submitted by the parties, including invoices, payment records, account statements, transaction logs, expert reports, payroll records, medical bills, repair estimates, sales data, profit-and-loss statements, tax records, interest schedules, policy limits, benefit schedules, or other financial materials. In some embodiments, the system may extract monetary values, dates, quantities, rates, and contractual terms from such materials and may organize the extracted information into structured damage variables. The system may then apply one or more computational models to determine a gross damages amount, an adjusted damages amount, or a net award amount.

In some embodiments, the system may determine monetary relief according to a rule set associated with a governing law, arbitral rule, contract term, insurance policy, employment agreement, service agreement, purchase agreement, lease, or other controlling instrument. For example, the system may apply contractual limitations on liability, deductibles, caps on recovery, minimum-payment provisions, fee-shifting clauses, indemnity clauses, holdback provisions, liquidated-damages clauses, or formulas specifying how damages are to be measured. In various embodiments, where multiple rules could apply, the system may determine priority among those rules and may select a damages methodology corresponding to the issues on which a party prevailed.

In various embodiments, the system may further account for reductions, offsets, or adjustments to an award. For example, the system may determine whether amounts already paid should be credited, whether mitigation reduces recoverable damages, whether comparative responsibility or apportionment should reduce recovery, whether a counterclaim should offset a claim amount, or whether duplicated categories of relief should be excluded to avoid double recovery. In some embodiments, the system may also calculate prejudgment interest, post-award interest, costs, arbitration fees, attorneys' fees, expert fees, or other monetary components where permitted by agreement, rule, or law. In this manner, the system may generate not only a liability determination, but also a complete monetary award reflecting additions and deductions associated with the adjudicated issues.

In some embodiments, the system may determine damages on an issue-by-issue basis and then aggregate the results into a final award. For example, the system may assign a first monetary consequence to a first proven issue, assign no monetary consequence to an unproven issue, assign a reduction to a third issue based on an affirmative defense, and then compute a final net amount by combining the issue-level outputs. In various embodiments, this issue-linked approach may permit the award to remain explainable, in that each monetary component may be traced back to one or more underlying factual findings, legal determinations, evidentiary inputs, or contractual provisions.

In various embodiments, the system may generate a reasoned or non-reasoned award. Where a reasoned award is generated, the system may identify which issues were decided in favor of which party and may further identify how those issue determinations contributed to the final monetary amount. In some embodiments, the system may produce an internal damages ledger, decision matrix, or structured remedial record that links each category of requested relief to a disposition status, an evidentiary basis, and a calculated amount. Such internal records may be used for review, auditing, human approval, or later enforcement, even where the final award presented to the parties contains less detail.

In some embodiments, the system may employ one or more machine learning models, rules engines, optimization models, or hybrid decision workflows to estimate damages where the evidentiary record is incomplete or where multiple valuation methods are possible. For example, the system may compare competing damages models proposed by the parties, determine which assumptions are better supported by the record, and select or synthesize an amount accordingly. In various embodiments, the system may assign confidence values to different components of a damages calculation and may flag low-confidence items for additional questioning, supplemental submissions, or human review.

In various embodiments, during an automated hearing, the system may generate questions directed to damages as well as liability. For example, the system may request clarification regarding payment history, invoice authenticity, mitigation efforts, market value, replacement cost, timing of breach, scope of performance, lost-profit assumptions, or the basis for a claimed fee request. Responses to such system-generated questions may be treated as additional evidence and may be used to confirm, revise, increase, reduce, or reject a proposed damages figure. In this manner, the disclosed system may iteratively refine both the entitlement determination and the amount of monetary relief.

In some embodiments, the final award generated by the system may therefore specify both who prevails on one or more claims, defenses, or issues and the monetary consequence of those determinations. The award may include a single net amount, separate line items for different categories of damages, conditional awards based on alternative findings, or staged payment obligations. Accordingly, the disclosed embodiments may be used not only to determine who wins a dispute, but also to translate issue-level adjudications into a monetary award derived from the evidentiary record and the applicable remedial framework.

In various embodiments, the disclosed systems, methods, and computer-readable media implement automated arbitration through a distributed computing architecture in which a server communicates over a network with claimant devices, respondent devices, administrator devices, and witness or deponent devices to receive, manage, and process dispute-related information in a structured, database-backed workflow. Rather than merely receiving arguments and producing a conclusion, the disclosed platform electronically controls notice, briefing, discovery, hearing, procedural-decision handling, evidence intake, backend preprocessing, authority retrieval, machine-learning classification, large-language-model reasoning, and output generation across multiple coordinated software modules and data stores. In various embodiments, submissions received from remote devices are associated with case identifiers, time-stamped, organized into a unified case record, and routed through staged processing pipelines that selectively invoke machine-learning decision modules, large-language-model reasoning modules, and human-review modules.

In various embodiments, the system transforms heterogeneous dispute inputs into machine-usable representations before an outcome is generated. For example, party briefs, uploaded evidence, deposition recordings, hearing responses, and procedural submissions may be aggregated into a preprocessing container that merges the received content into a unified data structure or merged file stored in one or more databases. The preprocessing container may inspect the received information between stages for prompt-hacking content, malicious payloads, or malformed data, thereby performing a security-focused filtering function before downstream reasoning occurs. The system may further transform raw textual inputs into feature representations usable by a plurality of classification models and, separately, into vector representations usable for similarity-based retrieval of supporting authorities. In this manner, the disclosed embodiments do not operate as a single-pass text generator, but instead as a pipeline that converts raw case submissions into multiple intermediate machine-processable forms adapted for classification, retrieval, verification, and generation.

In various embodiments, outcome determination may be performed using a machine-learning decision workflow that routes transformed case data to multiple classification models configured to predict encoded categorical outcomes, such as a claimant-favoring result, a respondent-favoring result, a partial result, or a dismissal. Outputs of the respective classification models may be aggregated using a weighted voting ensemble in which model votes are weighted according to model accuracy. A highest-probability outcome may then be returned as an outcome hypothesis for subsequent natural-language explanation generation. This architecture therefore includes a concrete multiclass computational classification operation applied to transformed case features before a written decision is drafted.

In various embodiments, the reasoning workflow grounds generated outputs in retrieved authority data using a multi-stage retrieval and verification pipeline. A legal query derived from the case record may be segmented to respect model context-window limits, processed to extract legal terminology, factual events, and legal rules, and vectorized into one or more embeddings. The resulting query vector may be compared against stored vectors in a vector index using cosine similarity, and the most similar vectors may be returned as candidate authorities. The candidate authorities may then be subjected to one or more secondary verification operations using a transformer model or other large language model different from the model used for primary drafting. Full opinion text for selected cases may then be retrieved from a case database and supplied, together with dispute-specific data, to one or more language models for generation of explanatory text. In various embodiments, this combination of vectorization, indexed similarity comparison, secondary model-based verification, and full-text retrieval provides a concrete technical mechanism for grounding generated outputs in stored authority materials.

In various embodiments, the disclosed platform further employs an agentic control layer, including an orchestration component referred to in the specification as Ra.ai, to reduce unsupported or insufficiently related outputs. In various embodiments, the agentic control layer receives vector-related case data from a backend database, determines a relevant jurisdiction according to a predetermined process, selects one or more models based on the determined jurisdiction, and filters candidate authorities to jurisdiction-specific materials or to selected source types such as rules or statutes. The filtered authorities may then be distributed across multiple category-specific databases, ranked by multiple artificial-intelligence agents, and consolidated into a selected information database containing higher-ranked sources. The selected information may then be inserted into analytical templates, including issue, rule, application, and conclusion templates, and processed by one or more language models to generate candidate analyses. The system may then apply a sufficiency check to the generated analyses and, if the analyses fail to satisfy the sufficiency criterion, iteratively re-run source selection, filtering, ranking, or template-based analysis generation. This iterative micro-task assignment, database-backed authority selection, and sufficiency-gated recursion supplies a concrete control architecture for refining output quality through repeated machine operations rather than through a single abstract decision step.

In various embodiments, the disclosed systems are further configured to process multiple evidentiary modalities and convert them into a normalized evidentiary record suitable for computational analysis. The system may receive documents, images, spreadsheets, datasets, contracts, correspondence, policies, logs, transcripts, declarations, audio recordings, video recordings, screen recordings, surveillance media, and deposition content. Audio and video materials may be automatically converted into text through speech-to-text transcription and may further be processed using speaker diarization, timestamp generation, segmentation by question and answer, and extraction of named entities or factual assertions. Scanned or image-based exhibits may be converted into machine-readable text using optical character recognition. The system may assign exhibit identifiers, group related exhibits, detect duplicate or conflicting versions of files, analyze metadata, check authenticity using one or more of cryptographic hashing, metadata verification, chain-of-custody validation, or anomaly detection, and assign evidentiary weight based on those analyses. These operations provide concrete data-normalization, validation, and organization mechanisms that improve the ability of the system to compare and reason over evidence originating in disparate formats.

In various embodiments, the disclosed systems may further evaluate witness or deponent credibility using automated analysis of text, audio, video, or multimodal testimony. For example, the system may compare a witness statement against documentary evidence, prior statements, objective records, or other testimony to identify corroboration, contradiction, omission, or inconsistency. The system may generate credibility-related metrics, such as a credibility score, confidence score, reliability score, inconsistency score, or corroboration score, using one or more machine-learning models, deep-learning models, transformer models, graph-based models, rules engines, or ensemble models. In some embodiments, the score may be based on features such as semantic consistency, factual overlap with other evidence, deviation from earlier testimony, response latency, linguistic hedging, specificity, contradiction frequency, source provenance, and authenticity indicators. Where audio or video is available, the system may additionally analyze speaker identity, pauses, hesitations, interruptions, turn-taking behavior, speaking rate, tone, facial movement, posture changes, or gesture patterns as inputs to the credibility-assessment process. The resulting evidentiary weights or credibility metrics may then be incorporated into downstream issue framing, fact finding, and award generation.

In various embodiments, the platform conducts an automated hearing process in which the system itself generates questions for one or more parties, witnesses, deponents, custodians, or experts based on unresolved factual disputes, conflicting evidence, missing foundation, ambiguous contractual language, or other identified gaps in the record. The system may transmit party-specific questions to remote devices, receive written answers, determine whether answers are responsive, evasive, incomplete, contradictory, unsupported, or corroborated, and store those responses as additional evidence within the case record. The hearing workflow may be iterative, such that responses or newly discovered issues may cause the system to request supplemental briefing, further evidence, or additional questioning. This automated question-generation and response-integration process provides a further concrete technical mechanism by which the system dynamically updates the evidentiary record before decision generation.

In various embodiments, the system is configured not only to determine prevailing parties on legal or factual issues, but also to compute monetary relief based on issue-by-issue determinations and evidentiary inputs. The platform may identify sub-issues such as contract formation, breach, causation, notice, waiver, damages entitlement, mitigation, setoff, and affirmative defenses; map specific issue outcomes to corresponding categories of relief, extract monetary values, dates, quantities, rates, and contractual terms from financial records and other evidentiary materials; and compute gross, adjusted, or net award amounts according to contractual provisions, policy terms, damages rules, offsets, caps, deductibles, fee-shifting provisions, or other remedial frameworks. In various embodiments, the system may generate an internal damages ledger, decision matrix, or structured remedial record linking each category of requested relief to supporting evidence, issue-level determinations, and calculated monetary amounts. The disclosed embodiments therefore include concrete computational mechanisms for translating issue resolution into quantified monetary awards.

In various embodiments, the system further addresses model limitations associated with long-context authority materials by using additional summarization operations before final drafting. Where retrieved opinions exceed the context-window threshold of a primary language model, a separate summarization model may first compress the opinion text and associated legal research into summarized content that can be supplied to downstream generation prompts. The system may then use templated prompts, such as issue-rule-application-conclusion templates, to produce written decisions, procedural rulings, or other responsive communications. Candidate outputs may be routed through a human-review stage, and review results may be stored in a reinforcement training database for later use in updating decision models, source-selection agents, or other components of the platform. In this manner, the platform includes concrete memory, storage, feedback, and model-improvement operations that persist post-generation evaluation data and use that data to improve later system performance.

Accordingly, the disclosed embodiments may be understood as directed to a specific computer-implemented arbitration architecture that performs structured intake from distributed devices, data normalization across multiple evidence modalities, malicious-input screening, feature extraction, multiclass ensemble classification, vector-based authority retrieval, transformer-based similarity verification, jurisdiction-specific source filtering, category-specific database routing, agent-based source ranking, sufficiency-controlled iterative analysis generation, automated hearing question generation, credibility and authenticity scoring, and issue-linked damages computation, followed by generation and transmission of a written decision with supporting rationale and citations. These coordinated operations improve the technical processing of dispute-related information by transforming heterogeneous user submissions into structured and verified machine-usable data, controlling how authority materials are retrieved and ranked, reducing unsupported outputs through iterative sufficiency checks, and producing database-backed, reviewable decision records suitable for electronic dispute-resolution workflows.

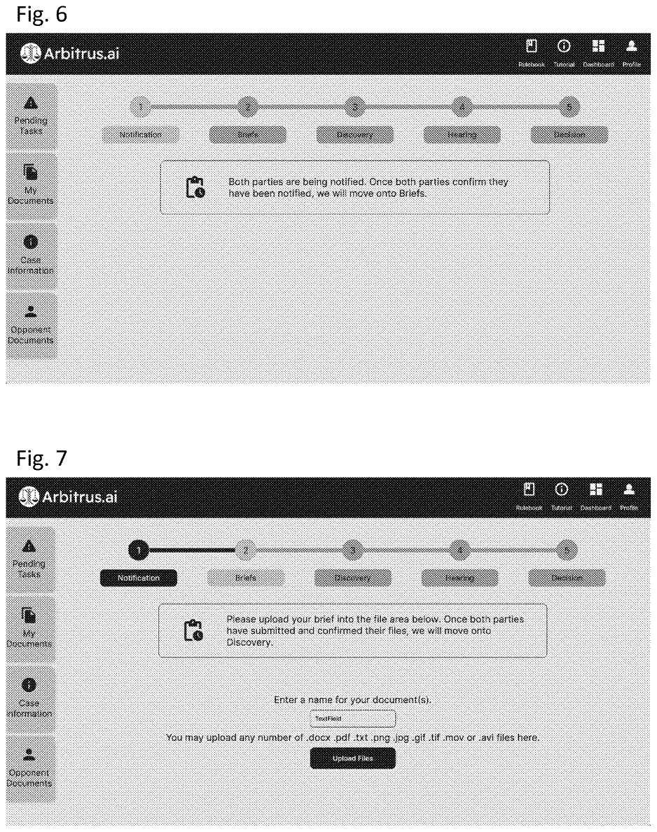

FIGS. 6-15 demonstrate different user interfaces of an example system as it may be viewed by one of the parties during an arbitration proceeding as described herein.

FIG. 6 illustrates an example user interface that may be presented to a party during an arbitration proceeding conducted using the disclosed systems, methods, and computer-readable media. In various embodiments, the user interface may be displayed on a user device associated with a claimant, respondent, or other authorized participant, and may provide a visual case-management workspace through which the party may review case status, access documents, and perform stage-specific tasks. In some embodiments, the user interface may include a timeline positioned across an upper portion of the interface, the timeline presenting a sequence of arbitration stages in chronological order. For example, the timeline may identify a notification stage as stage 1, a briefs stage as stage 2, a discovery stage as stage 3, a hearing stage as stage 4, and a decision stage as stage 5. In some embodiments, the timeline may indicate a current stage of the proceeding, previously completed stages, and one or more upcoming stages, thereby permitting the party to understand procedural status within the arbitration workflow.

In various embodiments, the timeline may be interactive such that selection of a given stage causes the interface to display materials, deadlines, submissions, or actions associated with that stage. In some embodiments, the notification stage may correspond to initial notice of the dispute, service-related information, or commencement materials; the briefs stage may correspond to claim statements, responses, legal arguments, and supporting submissions; the discovery stage may correspond to exchange of documents, evidence requests, and related procedural activity; the hearing stage may correspond to testimony, party responses, questioning, or presentation of evidence; and the decision stage may correspond to award generation, decision review, and output delivery. In this manner, the top-of-screen timeline may function as a procedural navigation element and as a status indicator for the arbitration. In other embodiments, a party may not be able to select which stage they are viewing, but rather will automatically show a current stage of the arbitration process (e.g., selection of the stage is controlled by the system, not a user/party).

In various embodiments, the user interface may further include, along a left side of the screen, a plurality of selectable tabs configured to expand and reveal additional content. In one example embodiment, the selectable tabs may include a pending tasks tab, a my documents tab, a case information tab, and an opponent's uploaded documents tab. In some embodiments, the pending tasks tab may display actions assigned to the party, including deadlines, unanswered questions, required submissions, requested evidence, or hearing-related obligations. The my documents tab may display documents uploaded, generated, or otherwise associated with the selecting party, including briefs, exhibits, correspondence, declarations, and other case materials. The case information tab may display general case metadata, including case identifiers, procedural status, governing rules, assigned deadlines, dispute subject matter, or participant information. The opponent's uploaded documents tab may display documents submitted by an opposing party for review, response, rebuttal, or use during a later stage of the proceeding.

In some embodiments, each tab may be collapsed or expanded independently, and expansion of a tab may cause corresponding content to be displayed in a main content region of the interface. In various embodiments, the disclosed arrangement may permit a party to navigate between procedural stages using the upper timeline while separately navigating between task-oriented and document-oriented views using the left-side tabs. Accordingly, FIG. 6 may illustrate one example of a user-facing interface by which the disclosed system organizes arbitration workflow data, party submissions, and procedural actions in a structured and stage-aware format.

FIG. 7 illustrates an example user interface presented during the briefs stage of an arbitration proceeding. In various embodiments, the user interface may be displayed on a party device and may include a procedural timeline extending across an upper portion of the interface. In the embodiment shown in FIG. 7, the briefs stage, corresponding to stage 2 of the proceeding, is highlighted to indicate that the arbitration is currently in a briefing phase. In some embodiments, the highlighting of the briefs stage may visually distinguish the current phase from prior phases and subsequent phases in the procedural sequence.

In various embodiments, the user interface may further present an upload dialog configured to permit the party to submit a brief to the system. In some embodiments, the upload dialog may include one or more controls for selecting a file from local device storage, dragging and dropping a file into the interface, identifying a document type, entering associated metadata, or confirming submission of the brief. In some embodiments, the uploaded brief may correspond to an initial brief, a responsive brief, a reply brief, a supplemental brief, or another written submission associated with the arbitration proceeding. The upload dialog may further be configured to transmit the selected file to one or more backend systems for storage, categorization, and later consideration during issue analysis, evidence review, hearing preparation, or decision generation.

In some embodiments, the user interface may also maintain access to additional navigation elements, including one or more expandable side-panel tabs, while the upload dialog is displayed. In this manner, FIG. 7 illustrates an example interface state in which a party is guided to provide briefing materials during the second stage of the arbitration workflow.

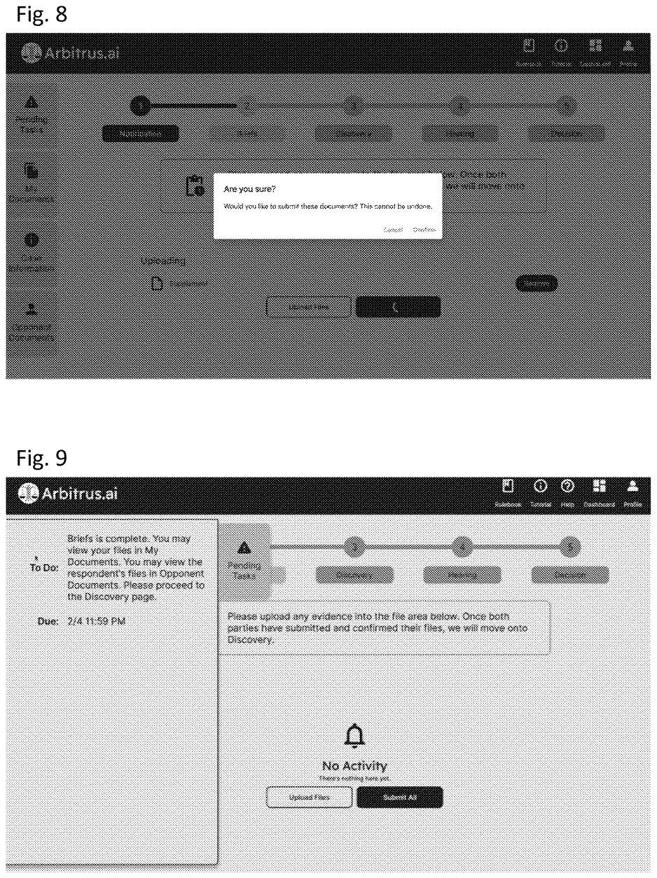

FIG. 8 illustrates an example user interface presented during the briefs stage of the arbitration proceeding after a party has initiated submission of a brief. In various embodiments, the user interface may continue to display the procedural timeline across an upper portion of the interface, with the briefs stage corresponding to stage 2 remaining highlighted to indicate that the proceeding is still in the briefing phase. In some embodiments, the user interface may further present a confirmation pop-up window overlaying at least a portion of the underlying interface. The confirmation pop-up window may be configured to prompt the user to confirm whether the user is ready to upload the brief and may further indicate that, once submitted, the upload cannot be undone. In some embodiments, the confirmation pop-up window may include a first selectable control to confirm submission of the brief and a second selectable control to cancel the submission and return to the prior interface state. In this manner, FIG. 8 illustrates an example confirmation step by which the disclosed system may reduce inadvertent submission of briefing materials during stage 2 of the arbitration workflow.

FIG. 9 illustrates an example user interface presented after submission of a brief during the briefs stage of the arbitration proceeding. In various embodiments, the user interface may display the pending tasks tab in an expanded state along the left side of the screen to show a current task or status notification for the party. In the example shown in FIG. 9, the expanded pending tasks tab may indicate that the brief has been successfully submitted. In some embodiments, the user interface may further indicate that the submitted brief is viewable through the my documents tab and that any documents submitted by an opposing party are viewable through the opponent documents tab.

In various embodiments, the expanded pending tasks tab may also provide procedural guidance for the next phase of the arbitration. For example, after confirming successful submission of the brief, the user interface may instruct the party to proceed to the discovery stage. In some embodiments, the user interface may therefore function not only as a repository for case materials, but also as a workflow-management tool that communicates completion of a current task, identifies locations of relevant case documents, and directs the party to a next stage in the proceeding.

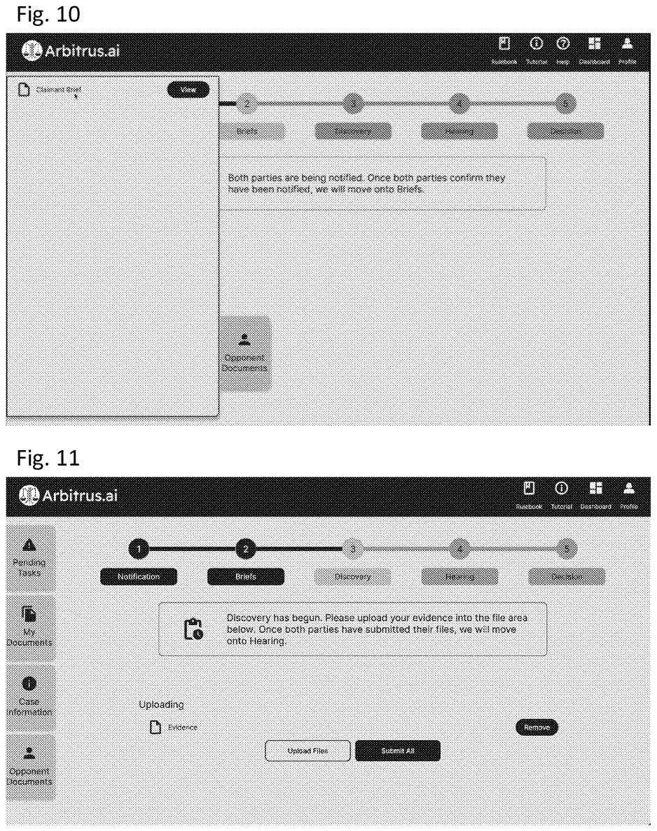

FIG. 10 illustrates an example user interface in which the opponent documents tab is selected to display documents uploaded by an opposing party during the arbitration proceeding. In various embodiments, selection of the opponent documents tab may cause the interface to present a list, panel, or document-view region showing one or more files, exhibits, briefs, attachments, or other materials submitted by the opposing party. In some embodiments, the displayed materials may be organized according to upload date, document type, proceeding stage, submitting party, or other case-related criteria.

In various embodiments, the interface may permit the viewing party to review the opposing party's uploaded materials for purposes of evaluation, response, rebuttal, preparation for discovery, or preparation for a hearing. In some embodiments, the displayed documents may include links, previews, file names, timestamps, or status indicators reflecting availability within the case record. In this manner, FIG. 10 illustrates an example interface state in which the disclosed system provides structured access to materials submitted by an opposing party.

FIG. 11 illustrates an example user interface in which stage 3, corresponding to the discovery stage, is selected. In various embodiments, the user interface may present a dialog configured to permit a party to upload discovery materials and evidence for use in the arbitration proceeding. In some embodiments, the dialog may permit the party to select one or more files from local storage, drag and drop files into the interface, identify document or evidence types, and confirm submission of the selected materials. The uploaded materials may include, for example, documents, exhibits, correspondence, records, images, audio files, video files, transcripts, declarations, or other evidence as described herein.

In various embodiments, materials uploaded through the dialog may be transmitted to one or more backend systems for storage, categorization, authentication analysis, and later use during issue evaluation, credibility analysis, hearing preparation, and decision generation. In some embodiments, the user interface may therefore provide a structured mechanism by which a party submits discovery-related content while the arbitration proceeding is in the discovery stage.

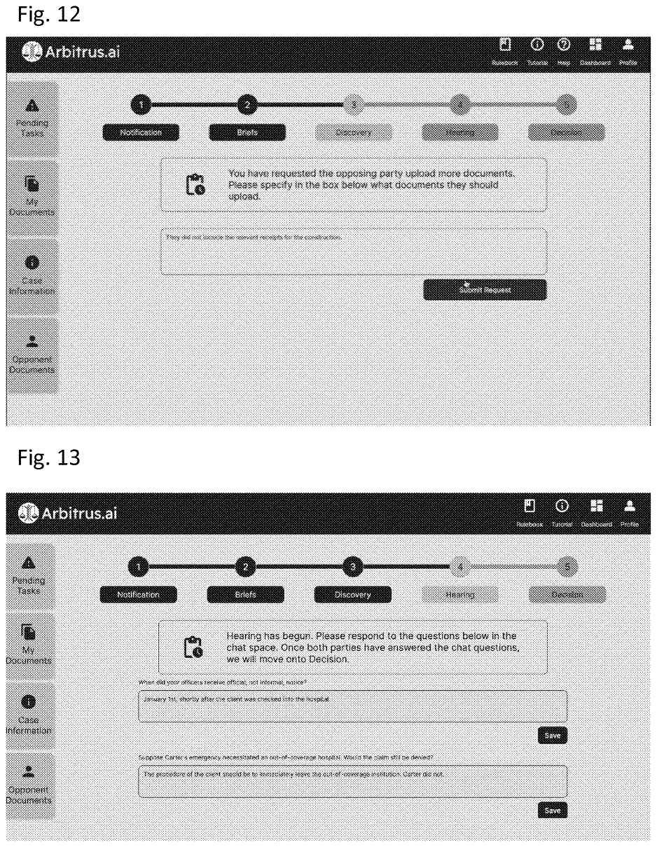

FIG. 12 illustrates an example user interface presented during the discovery stage in which a party is provided with a dialog for requesting that an opposing party upload a particular type of discovery. In various embodiments, the dialog may permit the requesting party to identify a category of requested discovery, such as documents, communications, transaction records, policies, logs, media files, contracts, financial records, or other evidence relevant to the arbitration proceeding. In some embodiments, the dialog may further permit the requesting party to enter descriptive information associated with the request, including a subject matter description, a date range, a custodian, a requested format, or other parameters that define the requested discovery with greater specificity.

In various embodiments, upon submission of the request, the system may store the request in the case record and may provide notice to the opposing party that the specified discovery has been requested. In some embodiments, the requested discovery may thereafter be tracked through the user interface as a pending item, and materials uploaded in response to the request may be associated with the discovery stage and made available for review within the case-management workflow. In this manner, FIG. 12 illustrates an example interface state in which the disclosed system facilitates party-directed discovery requests through a structured electronic dialog.

FIG. 13 illustrates an example user interface in which stage 4, corresponding to the hearing stage, is selected. In various embodiments, the user interface may present one or more questions generated by the system for the party to answer during the hearing stage of the arbitration proceeding. In some embodiments, the questions may be generated based on issues identified in the case record, disputed facts, inconsistencies between submissions, missing information, evidentiary gaps, or other matters requiring clarification.

In various embodiments, the user interface may further include one or more answer-entry dialogs positioned adjacent to or otherwise associated with the respective questions, thereby permitting the party to enter responses through the interface. In some embodiments, the interface may include a respective save control for each answer so that individual responses may be stored as they are entered. The user interface may further include a submission control configured to permit the party to submit all entered answers after completion. In some embodiments, responses submitted through the hearing-stage interface may be stored in the case record and used for subsequent evidentiary analysis, issue resolution, and decision generation. In this manner, FIG. 13 illustrates an example interface state in which the disclosed system presents system-generated hearing questions and receives corresponding party responses through structured answer dialogs.

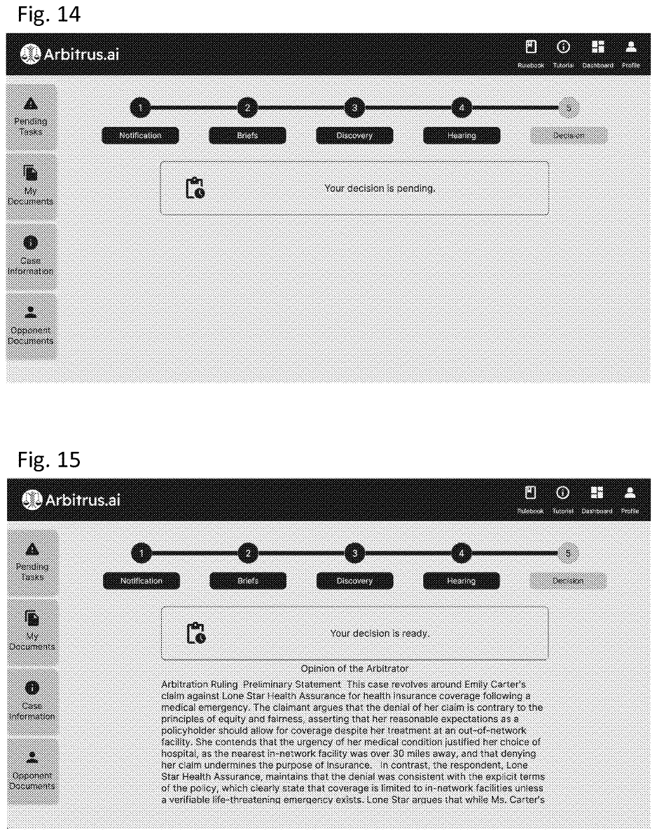

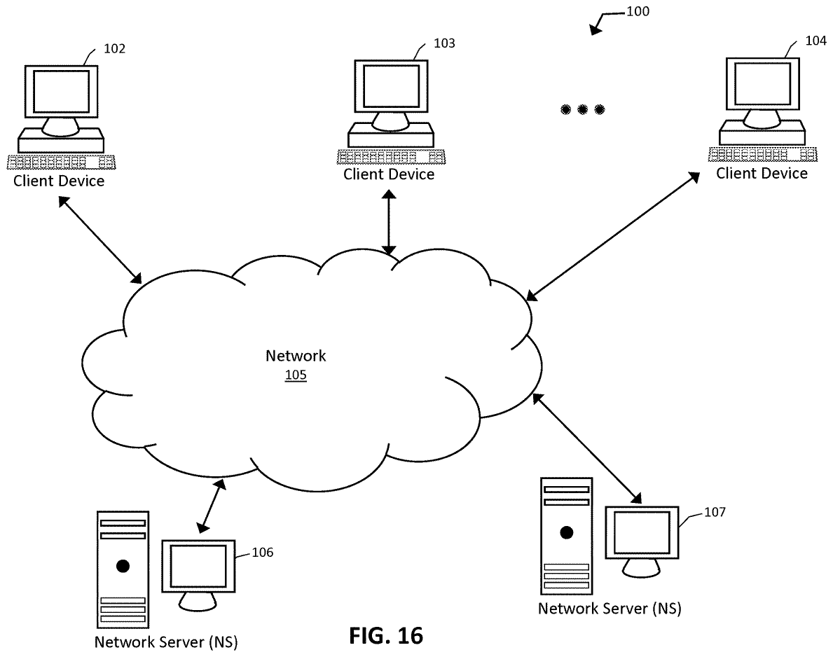

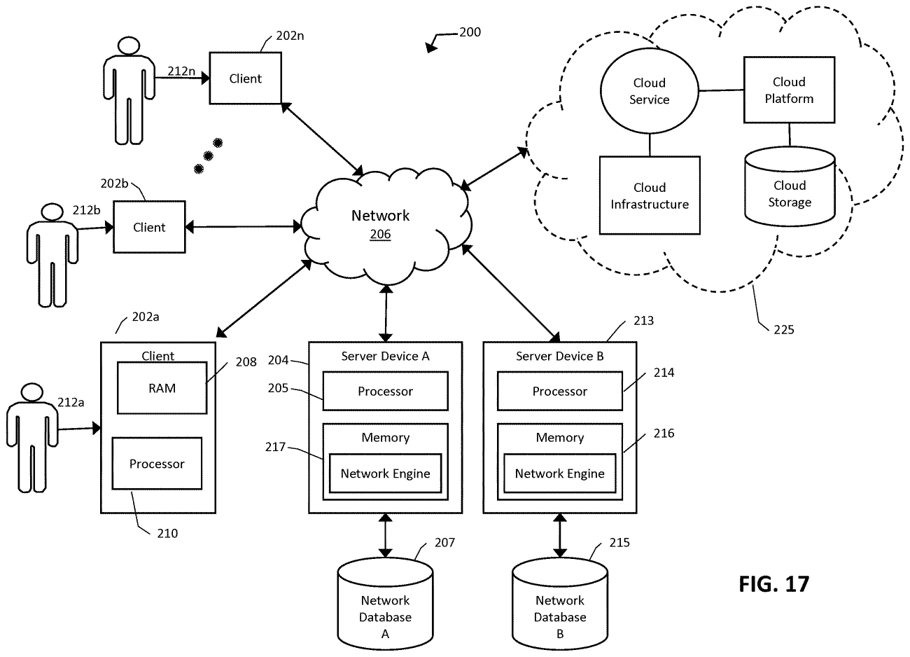

FIG. 14 illustrates an example user interface in which stage 5, corresponding to the decision stage, is selected. In various embodiments, the user interface may indicate to the party that a decision in the arbitration proceeding is pending. In some embodiments, the interface may present a status message, notification, or case-state indicator informing the party that submitted materials, responses, evidence, and hearing-stage inputs have been received and that the arbitration system is processing the case for decision generation. In various embodiments, the decision-stage interface may thereby communicate that the proceeding has advanced beyond the hearing stage and is awaiting completion of an opinion or award.

FIG. 15 illustrates an example user interface presented after completion of the decision stage of the arbitration proceeding. In various embodiments, the user interface may indicate that the decision is complete and may display the decision or opinion generated by the arbitration system. In some embodiments, the displayed decision or opinion may include one or more findings, determinations, explanations, awards, remedies, or other outcome-related content associated with resolution of the dispute. In various embodiments, the interface may permit the party to review the generated decision within the case-management environment after the arbitration system has completed its analysis. Although not shown in FIG. 15, in some embodiments, an interface similar to that illustrated in FIG. 15 may further include an option permitting the party to download the decision or opinion for local storage, printing, or later review.

Various embodiments are further described in the below numbered clauses.

Clause 1. A device comprising:
a memory; and
a processor coupled to the memory, the processor configured to execute instructions stored in the memory to:
   receive, from a claimant device, a claimant brief relating to a dispute;
   receive, from a respondent device, a respondent brief relating to the dispute;
   determine, based at least upon the claimant brief, the respondent brief, and rules derived from case law decisions, an outcome for the dispute;
   generate a written decision indicative of the outcome, wherein the written decision provides a rationale for the outcome and citations to the case law decisions supportive of the rationale and/or outcome; and
   send, to the claimant device and the respondent device, the written decision.

Clause 2. The clause of claim 1, wherein the processor is further configured to:
receive, from at least one of the claimant device or the respondent device, additional evidence associated with the dispute; and
determine the outcome and generate the decision further based at least in part on the additional evidence.

Clause 3. The device of clause 2, wherein the additional evidence comprises at least one of documents, images, spreadsheets, machine-readable datasets, contracts, correspondence, policies, logs, transcripts, or audit trails.

Clause 4. The device of clause 2, wherein the additional evidence comprises a deposition recording in at least one of video format or audio format.

Clause 5. The device of clause 4, wherein the processor is further configured to generate or receive a transcript of the deposition recording and determine the outcome and generate the decision further based at least in part on the transcript of the deposition recording.

Clause 6. The device of clause 4, wherein the processor is further configured to:
perform automated analyses on the deposition recording comprising at least one of speaker diarization, sentiment scoring, prosody analysis, pause/hesitation detection, truthfulness assessment, or credibility assessment; and
determine, based on the automated analyses, a weight to apply to the deposition recording, wherein the weight is indicative of an extent to which the deposition recording should be considered in determination of the outcome and generation of the written decision.

Clause 7. The device of clause 2, wherein the processor is further configured to evaluate the admissibility, relevance, and materiality of the additional evidence by applying the rules derived from the case law decisions

Clause 8. The device of clause 7, wherein the processor is further configured to exclude any of the additional evidence determined to be inadmissible, cumulative, privileged, or insufficiently authenticated.

Clause 9. The device of clause 2, wherein the processor is further configured to:
apply at least one authenticity check to the additional evidence, the at least one authenticity check comprising one or more of cryptographic hashing, metadata verification, chain-of-custody validation, or anomaly detection; and
assign evidentiary weight based on results of the authenticity check, wherein the evidentiary weight is indicative of an extent to which the additional evidence should be considered in determination of the outcome and generation of the written decision.

Clause 10. The device of clause 2, wherein the processor is further configured to conduct a written hearing comprising the processor being further configured to:
generate at least one question based on one or more of the claimant brief, the respondent brief, or the additional evidence;
send the at least one question to the claimant device or the respondent device;
receive a written answer to the question from the claimant device or the respondent device, and
determine the outcome and/or generate the written decision based at least in part on the written answer.

Clause 11. The device of clause 10, wherein the processor is configured to;
generate the at least one question using a rule-based or machine learning model that identifies unresolved issues, conflicting facts, and/or evidentiary gaps; and
tailor the at least one question to elicit clarifications and/or admissions material to the determination of the outcome.

Clause 12. The device of clause 10, wherein the processor is configured to impose response deadlines, track compliance, and/or decide objections or motions relating to the scope or propriety of the questions and answers; and to record interim procedural orders in the written decision or a separate procedural ruling.

Clause 13. The device of clause 10, wherein the processor is configured to aggregate the briefs, additional evidence, transcripts, recordings, automated analyses, and/or hearing answers into a case record; apply the rules derived from the case law decisions to the case record; and produce the written decision with rationale and citations reflecting consideration of each aggregated component.

Clause 14. The device of clause 7, wherein the processor is configured to disclose, in the written decision, any reliance on automated sentiment or truthfulness assessments, including any method employed and the evidentiary weight assigned; and to ground such reliance in cited authorities governing the use of such assessments.

Clause 15. The device of clause 2, wherein the processor is configured to receive and decide objections to the additional evidence and requests for supplemental submissions from the claimant device and the respondent device; and, when sustained, to order resubmission or supplementation and to incorporate any resubmitted evidence into the determination of the outcome and the generation of the written decision.

Clause 16. The device of clause 10, wherein the processor is configured to generate separate sets of questions for the claimant and the respondent that address party-specific assertions and evidentiary submissions, and to evaluate inconsistencies between the answers and the prior record when determining the outcome and generating the written decision.

Clause 17. The device of clause 1, wherein the processor is further configured to aggregate the claimant brief, the respondent brief, additional evidence, and hearing responses into a unified case data structure stored in a database, and to route the unified case data structure to both a machine learning decision module and a large language model reasoning module.

Clause 18. The device of clause 1, wherein the processor is further configured to preprocess text of the claimant brief and the respondent brief by transforming raw text into feature representations usable by a plurality of classification models.

Clause 19. The device of clause 1, wherein the processor is further configured to inspect received submissions for prompt-hacking content or malformed data before forwarding the submissions to a reasoning module.

Clause 20. The device of clause 1, wherein the processor is further configured to submit transformed case data to a plurality of classification models configured to generate respective encoded categorical outcomes, and to determine the outcome based on a weighted ensemble vote of the plurality of classification models.

Clause 21. The device of clause 1, wherein the processor is further configured to encode the outcome as one of a plurality of predefined outcome classes prior to generation of the written decision.

Clause 22. The device of clause 1, wherein the processor is further configured to vectorize a legal query derived from the claimant brief and the respondent brief, compare a resulting query vector to stored vectors in a vector index using cosine similarity, and retrieve one or more candidate case law decisions based on the comparison.

Clause 23. The device of clause 1, wherein the processor is further configured to verify similarity of the one or more candidate case law decisions using a transformer model different from a model used to generate the written decision.

Clause 24. The device of clause 1, wherein the processor is further configured to retrieve full opinion text corresponding to the one or more candidate case law decisions from a case database and provide the full opinion text with dispute-specific data to one or more language models for generation of the written decision.

Clause 25. The device of clause 1, wherein the processor is further configured to summarize retrieved opinion text prior to generation of the written decision when the retrieved opinion text exceeds a context-window threshold of a language model used to generate the written decision.

Clause 26. The device of clause 1, wherein the processor is further configured to determine a jurisdiction associated with the dispute, select a model based on the determined jurisdiction, and filter candidate case law decisions to authorities associated with the determined jurisdiction before generating the written decision.

Clause 27. The device of clause 1, wherein the processor is further configured to distribute candidate authorities among a plurality of category-specific databases, receive ranked source selections from a plurality of agents, and generate the written decision based on a subset of the ranked source selections.

Clause 28. The device of clause 1, wherein the processor is further configured to evaluate a generated analytical output against a sufficiency criterion and, responsive to determining that the generated analytical output fails the sufficiency criterion, iteratively re-run source selection or analysis generation before issuing the written decision.

Clause 29. The device of clause 1, wherein the processor is further configured to store post-generation review data in a reinforcement training database and update one or more decision models or source-selection agents based on the stored post-generation review data.

Clause 30. The device of clause 10, wherein generating the at least one question comprises generating the at least one question after aggregation of briefing-stage data, discovery-stage data, and hearing-stage data into a database-backed case record.

Clause 31. The device of clause 2, wherein the processor is further configured to receive deposition content during a discovery stage, associate the deposition content with a case identifier, and include the deposition content in the unified case data structure routed to the machine learning decision module and the large language model reasoning module.

Clause 32. The device of claim 1, wherein the processor is further configured to: aggregate data received during a notice stage, a briefing stage, a discovery stage, and a hearing stage into a case record associated with the arbitration; and store the case record in a database for subsequent generation of the written decision.

Clause 33. The device of claim 32, wherein the processor is further configured to: provide the claimant device and the respondent device with access to a graphical user interface through which submissions associated with the arbitration are received in a structured format.

Clause 34. The device of claim 1, wherein the processor is further configured to: receive an objection submitted during the arbitration; determine whether the objection is dispositive or non-dispositive; responsive to determining that the objection is dispositive, route a resulting output for human confirmation before issuance of a final ruling; and responsive to determining that the objection is non-dispositive, record a procedural decision and continue processing the arbitration.

Clause 35. The device of claim 32, wherein the processor is further configured to: merge positions, data, evidence, and responses of the claimant and the respondent into a single file stored in the database.

Clause 36. The device of claim 35, wherein the processor is further configured to: inspect information between preprocessing stages for prompt-hacking content or malicious data before forwarding the information to a downstream reasoning module.

Clause 37. The device of claim 35, wherein the processor is further configured to: transform raw text data of the case record into feature representations usable by a voting ensemble.

Clause 38. The device of claim 37, wherein the processor is further configured to: selectively route transformed raw text data to a machine learning decision module or to a large language model reasoning module.

Clause 39. The device of claim 1, wherein the processor is further configured to: process a vector associated with the arbitration in a backend database comprising a finite number of vector-relevant cases.

Clause 40. The device of claim 39, wherein the processor is further configured to: determine a jurisdiction associated with the arbitration according to a predetermined process; and select a large language model based on the determined jurisdiction.

Clause 41. The device of claim 40, wherein the processor is further configured to: filter candidate authorities based on the determined jurisdiction or according to a selected source-type filter.

Clause 42. The device of claim 41, wherein the processor is further configured to: sort returned authorities by category into a plurality of different databases.

Clause 43. The device of claim 42, wherein the processor is further configured to: receive, from a plurality of agents, rankings of sources returned from the plurality of different databases; and store highest-ranked sources in a selected information database.

Clause 44. The device of claim 43, wherein the processor is further configured to: pass information from the selected information database into a plurality of analytical templates; and apply one or more large language models to the plurality of analytical templates to generate analytical outputs.

Clause 45. The device of claim 44, wherein the processor is further configured to: evaluate whether the analytical outputs satisfy a sufficiency criterion; and responsive to determining that the analytical outputs fail to satisfy the sufficiency criterion, iteratively return the analytical outputs for additional source selection or analysis generation.

Clause 46. The device of claim 45, wherein the processor is further configured to: store analytical outputs that satisfy the sufficiency criterion in a legal analysis database; and use the stored analytical outputs in generating the written decision.

Clause 47. The device of claim 43, wherein the processor is further configured to: assign micro-tasks to the plurality of agents for selecting relevant authorities or generating candidate analyses, the micro-tasks being performed using one or more custom application programming interfaces or retrieval tools.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

It is understood that at least one aspect/functionality of various embodiments described herein can be performed in real-time and/or dynamically. As used herein, the term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a user interacting with an application on a mobile device) occurs, in order that results of the computation can be used in guiding the physical process.

As used herein, the term “dynamically” and term “automatically,” and their logical and/or linguistic relatives and/or derivatives, mean that certain events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, several hours, daily, several days, weekly, monthly, etc.

As used herein, the term “runtime” corresponds to any behavior that is dynamically determined during an execution of a software application or at least a portion of software application.

In some embodiments, exemplary inventive, specially programmed computing systems/platforms with associated devices are configured to operate in the distributed network environment, communicating with one another over one or more suitable data communication networks (e.g., the Internet, satellite, etc.) and utilizing one or more suitable data communication protocols/modes such as, without limitation, IPX/SPX, X.25, AX.25, AppleTalk™, TCP/IP (e.g., HTTP), Bluetooth™, near-field wireless communication (NFC), RFID, Narrow Band Internet of Things (NBIOT), 3G, 4G, 5G, GSM, GPRS, WiFi, WiMax, CDMA, satellite, ZigBee, and other suitable communication modes.

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

The aforementioned examples are, of course, illustrative and not restrictive.

As used herein, the term “user” shall have a meaning of at least one user. In some embodiments, the terms “user”, “subscriber” “consumer” or “customer” should be understood to refer to a user of an application or applications as described herein, and/or a consumer of data supplied by a data provider. By way of example, and not limitation, the terms “user” or “subscriber” can refer to a person who receives data provided by the data or service provider over the Internet in a browser session or can refer to an automated software application which receives the data and stores or processes the data.

FIG. 16 is a block diagram depicting a computer-based system and platform in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the exemplary inventive computing devices and/or the exemplary inventive computing components of the exemplary computer-based system/platform 100 may be configured to manage a large number of arbitrations and submissions from different party devices, as detailed herein. In some embodiments, the exemplary computer-based system/platform 100 may be based on a scalable computer and/or network architecture that incorporates varies strategies for assessing the data, caching, searching, and/or database connection pooling. An example of the scalable architecture is an architecture that is capable of operating multiple servers.

In some embodiments, referring to FIG. 16, members 102-104 (e.g., clients) of the exemplary computer-based system/platform 100 may include virtually any computing device capable of receiving and sending a message over a network (e.g., cloud network), such as network 105, to and from another computing device, such as servers 106 and 107, each other, and the like. In some embodiments, the member devices 102-104 may be personal computers, multiprocessor systems, microprocessor-based or programmable consumer electronics, network PCs, and the like. In some embodiments, one or more member devices within member devices 102-104 may include computing devices that typically connect using a wireless communications medium such as cell phones, smart phones, pagers, walkie talkies, radio frequency (RF) devices, infrared (IR) devices, CBs, integrated devices combining one or more of the preceding devices, or virtually any mobile computing device, and the like. In some embodiments, one or more member devices within member devices 102-104 may be devices that are capable of connecting using a wired or wireless communication medium such as a PDA, POCKET PC, wearable computer, a laptop, tablet, desktop computer, a netbook, a video game device, a pager, a smart phone, an ultra-mobile personal computer (UMPC), and/or any other device that is equipped to communicate over a wired and/or wireless communication medium (e.g., NFC, RFID, NBIOT, 3G, 4G, 5G, GSM, GPRS, WiFi, WiMax, CDMA, satellite, ZigBee, etc.). In some embodiments, one or more member devices within member devices 102-104 may include may run one or more applications, such as Internet browsers, mobile applications, voice calls, video games, videoconferencing, and email, among others. In some embodiments, one or more member devices within member devices 102-104 may be configured to receive and to send web pages, and the like. In some embodiments, an exemplary specifically programmed browser application of the present disclosure may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLLScript, XML, JavaScript, and the like. In some embodiments, a member device within member devices 102-104 may be specifically programmed by either Java, .Net, QT, C, C++ and/or other suitable programming language. In some embodiments, one or more member devices within member devices 102-104 may be specifically programmed include or execute an application to perform a variety of possible tasks, such as, without limitation, messaging functionality, browsing, searching, playing, streaming or displaying various forms of content, including locally stored or uploaded messages, images and/or video, and/or games.

In some embodiments, the exemplary network 105 may provide network access, data transport and/or other services to any computing device coupled to it. In some embodiments, the exemplary network 105 may include and implement at least one specialized network architecture that may be based at least in part on one or more standards set by, for example, without limitation, Global System for Mobile communication (GSM) Association, the Internet Engineering Task Force (IETF), and the Worldwide Interoperability for Microwave Access (WiMAX) forum. In some embodiments, the exemplary network 105 may implement one or more of a GSM architecture, a General Packet Radio Service (GPRS) architecture, a Universal Mobile Telecommunications System (UMTS) architecture, and an evolution of UMTS referred to as Long Term Evolution (LTE). In some embodiments, the exemplary network 105 may include and implement, as an alternative or in conjunction with one or more of the above, a WiMAX architecture defined by the WiMAX forum. In some embodiments and, optionally, in combination of any embodiment described above or below, the exemplary network 105 may also include, for instance, at least one of a local area network (LAN), a wide area network (WAN), the Internet, a virtual LAN (VLAN), an enterprise LAN, a layer 3 virtual private network (VPN), an enterprise IP network, or any combination thereof. In some embodiments and, optionally, in combination of any embodiment described above or below, at least one computer network communication over the exemplary network 105 may be transmitted based at least in part on one of more communication modes such as but not limited to: NFC, RFID, Narrow Band Internet of Things (NBIOT), ZigBee, 3G, 4G, 5G, GSM, GPRS, WiFi, WiMax, CDMA, satellite and any combination thereof. In some embodiments, the exemplary network 105 may also include mass storage, such as network attached storage (NAS), a storage area network (SAN), a content delivery network (CDN) or other forms of computer or machine readable media.

In some embodiments, the exemplary server 106 or the exemplary server 107 may be a web server (or a series of servers) running a network operating system, examples of which may include but are not limited to Microsoft Windows Server, Novell NetWare, or Linux. In some embodiments, the exemplary server 106 or the exemplary server 107 may be used for and/or provide cloud and/or network computing. Although not shown in FIG. 16, in some embodiments, the exemplary server 106 or the exemplary server 107 may have connections to external systems like email, SMS messaging, text messaging, ad content providers, etc. Any of the features of the exemplary server 106 may be also implemented in the exemplary server 107 and vice versa.

In some embodiments, one or more of the exemplary servers 106 and 107 may be specifically programmed to perform, in non-limiting example, as authentication servers, search servers, email servers, social networking services servers, SMS servers, IM servers, MMS servers, exchange servers, photo-sharing services servers, advertisement providing servers, financial/banking-related services servers, travel services servers, or any similarly suitable service-base servers for users of the member computing devices 101-104.

In some embodiments and, optionally, in combination of any embodiment described above or below, for example, one or more exemplary computing member devices 102-104, the exemplary server 106, and/or the exemplary server 107 may include a specifically programmed software module that may be configured to send, process, and receive information using a scripting language, a remote procedure call, an email, a tweet, Short Message Service (SMS), Multimedia Message Service (MMS), instant messaging (IM), internet relay chat (IRC), mIRC, Jabber, an application programming interface, Simple Object Access Protocol (SOAP) methods, Common Object Request Broker Architecture (CORBA), HTTP (Hypertext Transfer Protocol), REST (Representational State Transfer), or any combination thereof.

FIG. 16 depicts a block diagram of another exemplary computer-based system/platform 200 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the member computing devices 202a, 202b through 202n shown each at least includes a computer-readable medium, such as a random-access memory (RAM) 208 coupled to a processor 210 or FLASH memory. In some embodiments, the processor 210 may execute computer-executable program instructions stored in memory 208. In some embodiments, the processor 210 may include a microprocessor, an ASIC, and/or a state machine. In some embodiments, the processor 210 may include, or may be in communication with, media, for example computer-readable media, which stores instructions that, when executed by the processor 210, may cause the processor 210 to perform one or more steps described herein. In some embodiments, examples of computer-readable media may include, but are not limited to, an electronic, optical, magnetic, or other storage or transmission device capable of providing a processor, such as the processor 210 of client 202a, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, and etc.

In some embodiments, member computing devices 202a through 202n may also comprise a number of external or internal devices such as a mouse, a CD-ROM, DVD, a physical or virtual keyboard, a display, or other input or output devices. In some embodiments, examples of member computing devices 202a through 202n (e.g., clients) may be any type of processor-based platforms that are connected to a network 206 such as, without limitation, personal computers, digital assistants, personal digital assistants, smart phones, pagers, digital tablets, laptop computers, Internet appliances, and other processor-based devices. In some embodiments, member computing devices 202a through 202n may be specifically programmed with one or more application programs in accordance with one or more principles/methodologies detailed herein. In some embodiments, member computing devices 202a through 202n may operate on any operating system capable of supporting a browser or browser-enabled application, such as Microsoft™, Windows™, and/or Linux. In some embodiments, member computing devices 202a through 202n shown may include, for example, personal computers executing a browser application program such as Microsoft Corporation's Internet Explorer™, Apple Computer, Inc.'s Safari™, Mozilla Firefox, and/or Opera. In some embodiments, through the member computing client devices 202a through 202n, users 212a through 212n, may communicate over the exemplary network 206 with each other and/or with other systems and/or devices coupled to the network 206. As shown in FIG. 17, exemplary server devices 204 and 213 may be also coupled to the network 206. In some embodiments, one or more member computing devices 202a through 202n may be mobile clients.

In some embodiments, at least one database of exemplary databases 207 and 215 may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

As also shown in FIG. 17, some embodiments of the disclosed technology may also include and/or involve one or more cloud components 225, which are shown grouped together in the drawing for sake of illustration, though may be distributed in various ways as known in the art. Cloud components 225 may include one or more cloud services such as software applications (e.g., queue, etc.), one or more cloud platforms (e.g., a Web front-end, etc.), cloud infrastructure (e.g., virtual machines, etc.), and/or cloud storage (e.g., cloud databases, etc.).

According to some embodiments, the exemplary inventive computer-based systems/platforms, the exemplary inventive computer-based devices, components and media, and/or the exemplary inventive computer-implemented methods of the present disclosure may be specifically configured to operate in or with cloud computing/architecture such as, but not limiting to: infrastructure a service (IaaS), platform as a service (PaaS), and/or software as a service (SaaS).

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In some embodiments, one or more of exemplary inventive computer-based systems/platforms, exemplary inventive computer-based devices, and/or exemplary inventive computer-based components of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

As used herein, the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud components and cloud servers are examples.

In some embodiments, as detailed herein, one or more of the computer-based systems of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a message, a map, an entire application (e.g., a calculator), data points, and other suitable data. In some embodiments, as detailed herein, one or more of the computer-based systems of the present disclosure may be implemented across one or more of various computer platforms such as, but not limited to: (1) Linux™, (2) Microsoft Windows™, (3) OS X (Mac OS), (4) Solaris™, (5) UNIX™ (6) VMWare™, (7) Android™, (8) Java Platforms™, (9) Open Web Platform, (10) Kubernetes or other suitable computer platforms. In some embodiments, illustrative computer-based systems or platforms of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

In some embodiments, illustrative computer-based systems or platforms of the present disclosure may be configured to handle numerous concurrent users that may be, but is not limited to, at least 100 (e.g., but not limited to, 100-999), at least 1,000 (e.g., but not limited to, 1,000-9,999), at least 10,000 (e.g., but not limited to, 10,000-99,999), at least 100,000 (e.g., but not limited to, 100,000-999,999), at least 1,000,000 (e.g., but not limited to, 1,000,000-9,999,999), at least 10,000,000 (e.g., but not limited to, 10,000,000-99,999,999), at least 100,000,000 (e.g., but not limited to, 100,000,000-999,999,999), at least 1,000,000,000 (e.g., but not limited to, 1,000,000,000-999,999,999,999), and so on.

In some embodiments, exemplary inventive computer-based systems/platforms, exemplary inventive computer-based devices, and/or exemplary inventive computer-based components of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like. In various implementations, the display may be a holographic display. In various implementations, the display may be a transparent surface that may receive a visual projection. Such projections may convey various forms of information, images, and/or objects. For example, such projections may be a visual overlay for a mobile augmented reality (MAR) application.

In some embodiments, exemplary inventive computer-based systems/platforms, exemplary inventive computer-based devices, and/or exemplary inventive computer-based components of the present disclosure may be configured to be utilized in various applications which may include, but not limited to, gaming, mobile-device games, video chats, video conferences, live video streaming, video streaming and/or augmented reality applications, mobile-device messenger applications, and others similarly suitable computer-device applications.

As used herein, the term “mobile electronic device,” or the like, may refer to any portable electronic device that may or may not be enabled with location tracking functionality (e.g., MAC address, Internet Protocol (IP) address, or the like). For example, a mobile electronic device can include, but is not limited to, a mobile phone, Personal Digital Assistant (PDA), Blackberry™, Pager, Smartphone, or any other reasonable mobile electronic device.

As used herein, the terms “proximity detection,” “locating,” “location data,” “location information,” and “location tracking” refer to any form of location tracking technology or locating method that can be used to provide a location of, for example, a particular computing device/system/platform of the present disclosure and/or any associated computing devices, based at least in part on one or more of the following techniques/devices, without limitation: accelerometer(s), gyroscope(s), Global Positioning Systems (GPS); GPS accessed using Bluetooth™; GPS accessed using any reasonable form of wireless and/or non-wireless communication; WiFi™ server location data; Bluetooth™ based location data; triangulation such as, but not limited to, network based triangulation, WiFi™ server information based triangulation, Bluetooth™ server information based triangulation; Cell Identification based triangulation, Enhanced Cell Identification based triangulation, Uplink-Time difference of arrival (U-TDOA) based triangulation, Time of arrival (TOA) based triangulation, Angle of arrival (AOA) based triangulation; techniques and systems using a geographic coordinate system such as, but not limited to, longitudinal and latitudinal based, geodesic height based, Cartesian coordinates based; Radio Frequency Identification such as, but not limited to, Long range RFID, Short range RFID; using any form of RFID tag such as, but not limited to active RFID tags, passive RFID tags, battery assisted passive RFID tags; or any other reasonable way to determine location. For ease, at times the above variations are not listed or are only partially listed; this is in no way meant to be a limitation.

In some embodiments, the exemplary inventive computer-based systems/platforms, the exemplary inventive computer-based devices, and/or the exemplary inventive computer-based components of the present disclosure may be configured to securely store and/or transmit data by utilizing one or more of encryption techniques (e.g., private/public key pair, Triple Data Encryption Standard (3DES), block cipher algorithms (e.g., IDEA, RC2, RC5, CAST and Skipjack), cryptographic hash algorithms (e.g., MD5, RIPEMD-160, RTR0, SHA-1, SHA-2, Tiger (TTH), WHIRLPOOL, RNGs).

While one or more embodiments of the present disclosure have been described, it is understood that these embodiments are illustrative only, and not restrictive, and that many modifications may become apparent to those of ordinary skill in the art, including that various embodiments of the inventive methodologies, the inventive systems/platforms, and the inventive devices described herein can be utilized in any combination with each other. Further still, the various steps may be carried out in any desired order (and any desired steps may be added and/or any desired steps may be eliminated).

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments.

It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

What is claimed is:

1. A device comprising:
a memory; and
a processor coupled to the memory, the processor configured to execute instructions stored in the memory to:
receive, from a claimant device, a claimant brief relating to a dispute;
receive, from a respondent device, a respondent brief relating to the dispute;
determine, based at least upon the claimant brief, the respondent brief, and rules derived from case law decisions, an outcome for the dispute;
generate a written decision indicative of the outcome, wherein the written decision provides a rationale for the outcome and citations to the case law decisions supportive of the rationale and/or outcome; and
send, to the claimant device and the respondent device, the written decision.

2. The device of claim 1, wherein the processor is further configured to:
receive, from at least one of the claimant device or the respondent device, additional evidence associated with the dispute; and
determine the outcome and generate the decision further based at least in part on the additional evidence.

3. The device of claim 2, wherein the additional evidence comprises at least one of documents, images, spreadsheets, machine-readable datasets, contracts, correspondence, policies, logs, transcripts, or audit trails.

4. The device of claim 2, wherein the additional evidence comprises a deposition recording in at least one of video format or audio format.

5. The device of claim 4, wherein the processor is further configured to generate or receive a transcript of the deposition recording and determine the outcome and generate the decision further based at least in part on the transcript of the deposition recording.

6. The device of claim 4, wherein the processor is further configured to:
perform automated analyses on the deposition recording comprising at least one of speaker diarization, sentiment scoring, prosody analysis, pause/hesitation detection, truthfulness assessment, or credibility assessment; and
determine, based on the automated analyses, a weight to apply to the deposition recording, wherein the weight is indicative of an extent to which the deposition recording should be considered in determination of the outcome and generation of the written decision.

7. The device of claim 2, wherein the processor is further configured to evaluate the admissibility, relevance, and materiality of the additional evidence by applying the rules derived from the case law decisions

8. The device of claim 7, wherein the processor is further configured to exclude any of the additional evidence determined to be inadmissible, cumulative, privileged, or insufficiently authenticated.

9. The device of claim 2, wherein the processor is further configured to:
apply at least one authenticity check to the additional evidence, the at least one authenticity check comprising one or more of cryptographic hashing, metadata verification, chain-of-custody validation, or anomaly detection; and
assign evidentiary weight based on results of the authenticity check, wherein the evidentiary weight is indicative of an extent to which the additional evidence should be considered in determination of the outcome and generation of the written decision.

10. The device of claim 2, wherein the processor is further configured to conduct a written hearing comprising the processor being further configured to:
generate at least one question based on one or more of the claimant brief, the respondent brief, or the additional evidence;
send the at least one question to the claimant device or the respondent device;
receive a written answer to the question from the claimant device or the respondent device, and
determine the outcome and/or generate the written decision based at least in part on the written answer.

11. The device of claim 10, wherein the processor is configured to;
generate the at least one question using a rule-based or machine learning model that identifies unresolved issues, conflicting facts, and/or evidentiary gaps; and
tailor the at least one question to elicit clarifications and/or admissions material to the determination of the outcome.

12. The device of claim 10, wherein the processor is configured to impose response deadlines, track compliance, and/or decide objections or motions relating to the scope or propriety of the questions and answers; and to record interim procedural orders in the written decision or a separate procedural ruling.

13. The device of claim 10, wherein the processor is configured to aggregate the briefs, additional evidence, transcripts, recordings, automated analyses, and/or hearing answers into a case record; apply the rules derived from the case law decisions to the case record; and produce the written decision with rationale and citations reflecting consideration of each aggregated component.

14. The device of claim 7, wherein the processor is configured to disclose, in the written decision, any reliance on automated sentiment or truthfulness assessments, including any method employed and the evidentiary weight assigned; and to ground such reliance in cited authorities governing the use of such assessments.

15. The device of claim 2, wherein the processor is configured to receive and decide objections to the additional evidence and requests for supplemental submissions from the claimant device and the respondent device; and, when sustained, to order resubmission or supplementation and to incorporate any resubmitted evidence into the determination of the outcome and the generation of the written decision.

16. The device of claim 10, wherein the processor is configured to generate separate sets of questions for the claimant and the respondent that address party-specific assertions and evidentiary submissions, and to evaluate inconsistencies between the answers and the prior record when determining the outcome and generating the written decision.
